(19) United States
(12) Patent Application Publication
(10) Pub. No.: US 2021/0320325 A1
(43) Pub. Date: Oct. 14, 2021

(54) Solid Composition And Method For Producing Solid Electrolyte Molded Body

(71) Applicant: Seiko Epson Corporation, Toyko (JP)

(72) Inventors: Masahiro FURUSAWA, Chino (JP); Tomofumi YOKOYAMA, Matsumoto (JP); Naoyuki TOYODA, Suwa (JP); Hitoshi YAMAMOTO, Chino (JP); Tsutomu TERAOKA, Matsumoto (JP)

(21) Appl. No.: 17/227,446

(22) Filed: Apr. 12, 2021

(30) Foreign Application Priority Data
Apr. 13, 2020 (JP) 2020-071539

(51) Int. Cl. H01M 10/0562

(52) U.S. Cl. CPC H01M 10/0562; H01M 10/0525; H01M 2300/0071

(57) ABSTRACT

A solid composition according to the present disclosure includes first particles constituted by a first solid electrolyte containing at least lithium, an oxide having a different formulation from the first solid electrolyte, and an oxoacid compound. It is preferred that the oxide and the oxoacid compound are contained in second particles that are different from the first particles. It is preferred that the oxoacid compound contains at least one of a nitrate ion and a sulfate ion as an oxoanion.

The present application is based on, and claims priority from JP Application Serial Number 2020-071539, filed on Apr. 13, 2020, the disclosure of which is hereby incorporated by reference herein in its entirety.

### BACKGROUND

### 1. Technical Field

The present disclosure relates to a solid composition and a method for producing a solid electrolyte molded body.

### 2. Related Art

Recently, rapid charge-discharge characteristics have come to be required as characteristics required for a lithium-ion secondary battery, and a drastic decrease in charge-discharge capacity occurring during rapid charge-discharge has become a problem. Therefore, an attempt to decrease an electrical resistance of an active material layer that is a constituent member of a battery or a so-called internal resistance such as an ion conduction resistance of a separator layer has been made, and in particular, a technique for decreasing an internal resistance of a positive electrode active material layer that occupies a large proportion of an internal resistance of a battery has attracted attention. In order to decrease the internal resistance of the positive electrode active material layer, a case where an active material composite material is molded thin to decrease the resistance value, a case where a carbon nanotube is adopted as an electric conduction assistant, a case where oxygen constituting a positive electrode active material is partially substituted with nitrogen, thereby increasing the electron conduction property of the positive electrode active material itself, and the like have already been put to practical use.

However, in the course of charge transfer occurring when lithium ions transfer between the positive electrode active material and the solid electrolyte, when interface formation is not sufficient, lithium ions are lacking in the vicinity of the interface and a charge transfer reaction no longer proceeds. Therefore, even if the internal resistance is decreased by an electrical design method, there is a limit to the formation of an all-solid-state battery that can withstand practical use.

Therefore, recently, an attempt to decrease a charge transfer resistance and also avoid ion deficiency during high-rate charge-discharge by arranging a material that acts on the electrical condition of an interface where charge transfer occurs between the positive electrode active material and the solid electrolyte has attracted attention.

For example, JP-A-2018-147726 (Patent Document 1) discloses a positive electrode material having a structure in which a ferroelectric is disposed at a surface of a positive electrode active material, and according to this, a so-called hot spot where a lithium ion concentration is locally high is formed to increase the charge transfer frequency, whereby the charge transfer resistance during high-rate charge-discharge is tried to be decreased.

Further, JP-A-2019-3786 (Patent Document 2) discloses a positive electrode active material having a structure in which a specific active material particle is coated with a specific coating layer, and according to this, the same effect as described above is tried to be obtained.

However, according to the configuration described in Patent Document 1, the ferroelectric itself does not have an ion conduction property, and therefore, the internal resistance increases instead at commonly used low-load charge-discharge, and there is a problem that the capacity is decreased.

Further, according to the configuration described in Patent Document 2, an ion conductor is likely to become porous, and although an effect of improving the charge-discharge capacity maintenance rate at a low load was observed, it was not a technique enough for drastically improving the charge-discharge performance at a high load.

### SUMMARY

The present disclosure has been made for solving the above problems and can be realized as the following application examples.

A solid composition according to an application example of the present disclosure includes: first particles constituted by a first solid electrolyte containing at least lithium; an oxide having a different formulation from the first solid electrolyte; and an oxoacid compound.

Further, a method for producing a solid electrolyte molded body according to an application example of the present disclosure includes: a molding step of obtaining a molded body using the solid composition according to the present disclosure; and a heat treatment step of subjecting the molded body to a heat treatment so as to react the oxide and the oxoacid compound in the solid composition to cause conversion to a second solid electrolyte thereby forming a solid electrolyte molded body containing the first solid electrolyte and the second solid electrolyte.

### BRIEF DESCRIPTION OF THE DRAWINGS

FIG. 1 is a cross-sectional view schematically showing a solid composition according to the present disclosure.

FIG. 2 is a schematic perspective view schematically showing a configuration of a lithium-ion secondary battery of a first embodiment.

FIG. 3 is a schematic perspective view schematically showing a configuration of a lithium-ion secondary battery of a second embodiment.

FIG. 4 is a schematic cross-sectional view schematically showing a structure of the lithium-ion secondary battery of the second embodiment.

FIG. 5 is a schematic perspective view schematically showing a configuration of a lithium-ion secondary battery of a third embodiment.

FIG. 6 is a schematic cross-sectional view schematically showing a structure of the lithium-ion secondary battery of the third embodiment.

FIG. 7 is a schematic perspective view schematically showing a configuration of a lithium-ion secondary battery of a fourth embodiment.

FIG. 8 is a schematic cross-sectional view schematically showing a structure of the lithium-ion secondary battery of the fourth embodiment.

FIG. 9 is a flowchart showing a method for producing the lithium-ion secondary battery of the first embodiment.

FIG. 10 is a schematic view schematically showing the method for producing the lithium-ion secondary battery of the first embodiment.

FIG. 11 is a schematic view schematically showing the method for producing the lithium-ion secondary battery of the first embodiment.

FIG. 12 is a schematic cross-sectional view schematically showing another method for forming a solid electrolyte layer.

FIG. 13 is a flowchart showing a method for producing the lithium-ion secondary battery of the second embodiment.

FIG. 14 is a schematic view schematically showing the method for producing the lithium-ion secondary battery of the second embodiment.

FIG. 15 is a schematic view schematically showing the method for producing the lithium-ion secondary battery of the second embodiment.

FIG. 16 is a flowchart showing a method for producing the lithium-ion secondary battery of the third embodiment.

FIG. 17 is a schematic view schematically showing the method for producing the lithium-ion secondary battery of the third embodiment.

FIG. 18 is a schematic view schematically showing the method for producing the lithium-ion secondary battery of the third embodiment.

FIG. 19 is a flowchart showing a method for producing the lithium-ion secondary battery of the fourth embodiment.

FIG. 20 is a schematic view schematically showing the method for producing the lithium-ion secondary battery of the fourth embodiment.

### DESCRIPTION OF EXEMPLARY EMBODIMENTS

Hereinafter, preferred embodiments of the present disclosure will be described in detail.

### [1] Solid Composition

First, a solid composition according to the present disclosure will be described.

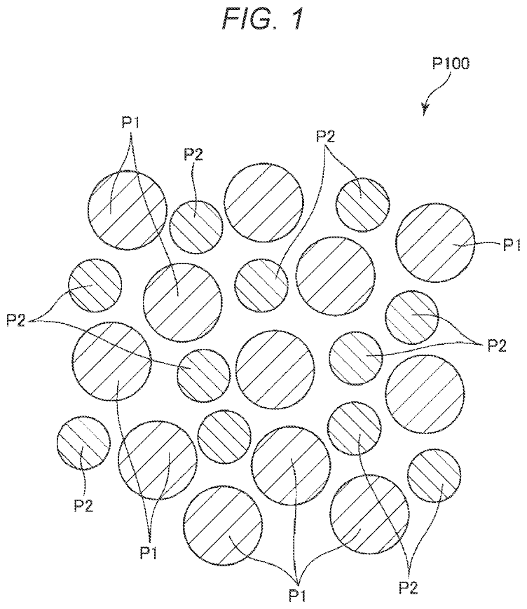

FIG. 1 is a cross-sectional view schematically showing the solid composition according to the present disclosure.

The solid composition according to the present disclosure is used for forming a solid electrolyte molded body which will be described in detail later. In particular, the solid composition according to the present disclosure includes first particles constituted by a first solid electrolyte containing at least lithium, an oxide having a different formulation from the first solid electrolyte, and an oxoacid compound. The oxide and the oxoacid compound are converted into a second solid electrolyte by reacting with each other.

According to such a configuration, a solid composition which can be favorably used for producing a solid electrolyte molded body that has a low solid electrolyte grain boundary resistance and an excellent ion conductivity and that is constituted by a solid electrolyte having a high denseness can be provided. More specifically, by containing an oxoacid compound, the melting point of the oxide contained in the solid composition can be lowered. According to this, the oxide that is a constituent material of the solid composition can be converted into the second solid electrolyte while promoting the crystal growth, and also the adhesion between the second solid electrolyte and the first solid electrolyte that constitutes the first particles, and the adhesion of the particles of the second solid electrolyte corresponding to second particles which will be described in detail later, or the like can be made excellent by a firing treatment that is a heat treatment at a relatively low temperature for a relatively short time. As a result, the solid electrolyte molded body to be formed has a high denseness, a low solid electrolyte grain boundary resistance, and an excellent ion conductivity. Further, due to an action capable of causing a reaction to incorporate lithium ions into the oxide during the reaction, the second solid electrolyte that is a lithium-containing composite oxide can be formed at a low temperature. Therefore, for example, a decrease in ion conductivity due to volatilization of lithium ions can be suppressed, and it can be favorably applied to the production of an all-solid-state battery having an excellent battery capacity at a high load.

On the other hand, when the conditions as described are not satisfied, satisfactory results are not obtained.

For example, when the solid composition is constituted only by particles composed of the first solid electrolyte, when the composition is fired, a void is likely to remain between the particles, and a molded body of a solid electrolyte having a sufficiently high denseness cannot be obtained. As a result, the molded body of a solid electrolyte to be obtained has a high solid electrolyte grain boundary resistance and thus has a poor ion conductivity. In particular, when firing of the composition is performed at a relatively low temperature as described later, such a problem more prominently occurs.

Further, even if the solid composition contains the oxoacid compound together with the oxide, when the solid composition does not contain the first solid electrolyte, it becomes difficult to sufficiently increase the denseness when the solid composition is fired.

Further, even if the solid composition contains the oxide together with the first particles, when the solid composition does not contain the oxoacid compound, the effect of lowering the melting point of the oxide cannot be obtained, and when the solid composition is fired, a void is likely to remain between particles, and a molded body of a solid electrolyte having a sufficiently high denseness cannot be obtained. As a result, the resulting molded body of a solid electrolyte has a high solid electrolyte grain boundary resistance and thus has a poor ion conductivity. In particular, when firing of the composition is performed at a relatively low temperature as described later, such a problem more prominently occurs.

Further, even if the solid composition contains the oxoacid compound together with the first particles, when the solid composition does not contain the oxide, the second solid electrolyte that is a lithium-containing composite oxide cannot be formed.

As described above, the oxide is converted into the second solid electrolyte by reacting with the oxoacid compound. In other words, it can be said that the oxide is a precursor of the second solid electrolyte. Therefore, in the following description, the oxide is also referred to as “precursor oxide”.

The solid composition according to the present disclosure need only include the first particles, the precursor oxide, and the oxoacid compound, and may contain these components in any form, however, in the configuration shown in FIG. 1, a solid composition P100 includes first particles P1 and second particles P2 constituted by a material containing a precursor oxide and an oxoacid compound. In other words, the precursor oxide and the oxoacid compound are contained in the second particles P2 that are different from the first particles P1.

According to such a configuration, the reaction of the precursor oxide with the oxoacid compound can be allowed to more efficiently proceed when producing the solid electrolyte molded body which will be described in detail later, so that the solid electrolyte molded body to be obtained can be made to have a lower solid electrolyte grain boundary resistance, a more excellent ion conductivity, and a higher denseness. Further, the productivity of the solid electrolyte molded body can be further enhanced.

Hereinafter, a case where the solid composition P100 includes the first particles P1 and the second particles P2 will be mainly described.

### [1-1] First Particles

The first particles P1 are constituted by the first solid electrolyte containing at least lithium.

### [1-1-1] First Solid Electrolyte

The first solid electrolyte may have any formulation as long as it functions itself as a solid electrolyte, and may be, for example, an oxysulfide or an oxynitride, but is preferably an oxide.

According to this, generation of a poisonous gas is suppressed, and atmospheric stability is improved.

The first solid electrolyte may have any crystal phase, and for example, a garnet-type oxide solid electrolyte, a perovskite-type oxide solid electrolyte, a NASICON-type oxide solid electrolyte, and the like are exemplified.

When the first solid electrolyte is a garnet-type oxide solid electrolyte, an effect that the ion conductivity of the solid electrolyte after sintering is increased, and also the mechanical strength thereof is increased, and the stability is improved so as to enhance the safety of a battery is obtained.

When the first solid electrolyte is a perovskite-type oxide solid electrolyte, sinterability at a lower temperature can be achieved.

When the first solid electrolyte is a NASICON-type oxide solid electrolyte, the atmospheric stability is improved.

As the garnet-type oxide solid electrolyte, for example, Li₇La₃Zr₂O₇, and a material obtained by partially substituting the Li, La, and Zr sites thereof with any of various metals, for example, Li_{6.75}La₃Zr_{1.75}Ta_{0.25}O₇, Li_{6.3}La₃Zr_{1.3}Sb_{0.5}Ta_{0.2}O₇, Li_{6.7}Al_{0.1}La₃Zr₂O₇, and the like are exemplified.

As the perovskite-type oxide solid electrolyte, for example, La_{0.57}Li_{0.29}TiO₃ and the like are exemplified.

As the NASICON-type oxide solid electrolyte, for example, Li₁₊ₓAlₓTi₂₋ₓ (PO₄)₃ and the like are exemplified.

### [1-1-2] Another Component

The first particles P1 need only be constituted by a material containing the above-mentioned first solid electrolyte, and may further contain another component in addition to the first solid electrolyte. As such another component, for example, the precursor oxide, the oxoacid compound, or the second solid electrolyte as described in detail later, or a solvent component used in the process for producing the solid composition P100, or the like is exemplified.

However, the content of the component other than the first solid electrolyte in the first particles P1 is preferably 10 mass % or less, more preferably 5.0 mass % or less, further more preferably 0.5 mass % or less.

### [1-1-3] Overall Configuration of First Particles

The average particle diameter of the first particles P1 is not particularly limited, but is preferably 1.0 μm or more and 30 μm or less, more preferably 2.0 μm or more and 20 μm or less, and further more preferably 3.0 μm or more and 8.0 μm or less.

According to this, the fluidity and ease of handling of the solid composition P100 can be made more favorable. Further, in the solid electrolyte molded body to be produced using the solid composition P100, the first solid electrolyte and the second solid electrolyte can be distributed in a more favorable form, and the solid electrolyte grain boundary resistance in the solid electrolyte molded body can be further decreased, so that the ion conductivity and denseness can be further increased. Further, this is also advantageous from the viewpoint of improvement of the productivity of the solid composition P100 and reduction of the production cost.

Note that in this specification, the average particle diameter refers to a volume-based average particle diameter, and can be determined by, for example, subjecting a dispersion liquid prepared by adding a sample to methanol and dispersing the sample for 3 minutes using an ultrasonic disperser to measurement with a particle size distribution analyzer according to the Coulter counter method (model TA-II, manufactured by Coulter Electronics, Inc.) using an aperture of 50 μm.

In the drawing, the first particle P1 has a perfect spherical shape, but the shape of the first particle P1 is not limited thereto.

The solid composition P100 generally includes a plurality of first particles P1, but may include, for example, the first particles P1 having mutually different conditions. For example, the solid composition P100 may include the first particles P1 in which at least one of the particle diameter, shape, and formulation is different.

The content of the first particles P1 in the solid composition P100 is preferably 40 mass % or more and 95 mass % or less, more preferably 45 mass % or more and 90 mass % or less, and further more preferably 57 mass % or more and 83 mass % or less.

According to this, the ratio of the first particles P1 to the second particles P2 in the solid composition P100 is easily adjusted within a favorable range, and the solid electrolyte molded body to be produced using the solid composition P100 can be made to have a lower solid electrolyte grain boundary resistance, a more excellent ion conductivity, and a higher denseness. Further, the charge-discharge performance at a high load in a lithium-ion secondary battery to which the solid composition P100 is applied can be made more excellent.

### [1-2] Second Particles

The second particles P2 have a different formulation from the first particles P1.

The second particles P2 contain an oxide having a different formulation from the first solid electrolyte, that is, a precursor oxide, and an oxoacid compound.

### [1-2-1] Precursor Oxide

The precursor oxide constituting the second particles P2 is different from the first solid electrolyte constituting the first particles P1. More specifically, for example, even if the first solid electrolyte constituting the first particles P1 is an oxide solid electrolyte, the precursor oxide constituting the second particles P2 has a different formulation, a different crystal phase at normal temperature and normal pressure, or the like from the oxide constituting the first particles P1.

Note that in this specification, “normal temperature and normal pressure” refers to 25° C. and 1 atm. Further, in this specification, the “different” in terms of crystal phase is a broad concept not only including that the type of crystal phase is not the same, but also including that even if the type is the same, at least one lattice constant is different, or the like.

The crystal phase of the precursor oxide may be any, but is preferably a pyrochlore-type crystal.

According to this, even when a heat treatment for the solid composition P100 is performed at a lower temperature for a shorter time, the solid electrolyte molded body having a particularly excellent ion conduction property can be favorably obtained. In particular, when the crystal phase of the first solid electrolyte is a cubic garnet-type crystal, when the crystal phase of the precursor oxide is a pyrochlore-type crystal, the adhesion between the first solid electrolyte constituting the first particles P1 and the second solid electrolyte formed by the constituent materials of the second particles P2 can be made more excellent. As a result, the solid electrolyte molded body to be produced using the solid composition P100 can be made to have a lower grain boundary resistance, a higher ion conductivity, and a higher denseness.

The crystal phase of the precursor oxide may be a crystal phase other than the pyrochlore-type crystal, for example, a cubic crystal having a perovskite structure, a rock salt-type structure, a diamond structure, a fluorite-type structure, a spinel-type structure, or the like, an orthorhombic crystal such as a ramsdellite-type crystal, a trigonal crystal such as a corundum-type crystal, or the like.

The formulation of the precursor oxide is not particularly limited, however, the precursor oxide is preferably a composite oxide containing La, Zr, and M wherein M is at least one type of element selected from the group consisting of Nb, Ta, and Sb.

According to this, even when a heat treatment for the solid composition P100 is performed at a lower temperature for a shorter time, the solid electrolyte molded body having a particularly excellent ion conduction property can be favorably obtained. In addition, for example, in an all-solid-state battery, the adhesion of the solid electrolyte to be formed to a positive electrode active material or a negative electrode active material can be made more excellent, and a composite material can be formed so as to have a more favorable close contact interface, and thus, the properties and reliability of the all-solid-state battery can be made more excellent.

The M need only be at least one type of element selected from the group consisting of Nb, Ta, and Sb, but is preferably two or more types of elements selected from the group consisting of Nb, Ta, and Sb.

According to this, the above-mentioned effect is more remarkably exhibited.

When the precursor oxide is a composite oxide containing La, Zr, and M, it is preferred that the ratio of substance amounts of La, Zr, and M contained in the precursor oxide is 3:2−x:x, and a relationship: 0<x<2.0 is satisfied.

According to this, the above-mentioned effect is more remarkably exhibited.

When the precursor oxide is an oxide containing Li, it can be said that the oxide is a precursor oxide and also is a lithium compound.

The crystal grain diameter of the precursor oxide is not particularly limited, but is preferably 10 nm or more and 200 nm or less, more preferably 15 nm or more and 180 nm or less, and further more preferably 20 nm or more and 160 nm or less.

According to this, due to a so-called Gibbs-Thomson effect that is a phenomenon of lowering the melting point with an increase in surface energy, the melting temperature of the precursor oxide or the firing temperature of the solid composition P100 can be further lowered. Further, this is also advantageous to the improvement of joining of the solid electrolyte molded body to be formed using the solid composition P100 to a heterogeneous material or the reduction of the defect density.

The precursor oxide is preferably constituted by a substantially single crystal phase.

According to this, the precursor oxide undergoes crystal phase transition substantially once when producing the solid electrolyte molded body using the solid composition P100, that is, when generating a high-temperature crystal phase, and therefore, segregation of elements accompanying the crystal phase transition or generation of a contaminant crystal by thermal decomposition is suppressed, so that various properties of the solid electrolyte molded body to be produced are further improved.

In a case where only one exothermic peak is observed in a range of 300° C. or higher and 1,000° C. or lower when measurement is performed by TG-DTA at a temperature raising rate of 10° C./min for the precursor oxide, it can be determined that “it is constituted by a substantially single crystal phase”.

The content of the precursor oxide in the second particles P2 is not particularly limited, but is preferably 35 mass % or more and 85 mass % or less, more preferably 45 mass % or more and 85 mass % or less, and further more preferably 55 mass % or more and 85 mass % or less.

According to this, even when a heat treatment for the solid composition P100 is performed at a lower temperature for a shorter time, the solid electrolyte molded body having a particularly excellent ion conduction property can be favorably obtained.

In the plurality of second particles P2 constituting the solid composition P100, the contents of the precursor oxide may be different. In such a case, as the value of the content of the precursor oxide in the second particles P2, the average value of the contents of the precursor oxide in the plurality of second particles P2 constituting the solid composition P100 shall be adopted. In other words, the ratio of the total mass of the precursor oxide to the mass of the assembly of all the second particles P2 constituting the solid composition P100 shall be adopted.

Further, the solid composition P100 may contain multiple types of precursor oxides. In that case, multiple types of precursor oxides may be contained in a single second particle P2, or the solid composition P100 may contain different types of precursor oxides to be contained as multiples types of second particles P2.

### [1-2-2] Lithium Compound

The second particles P2 contain a lithium compound.

According to this, the second solid electrolyte to be formed using the second particles P2 can be configured to be composed of a lithium-containing composite oxide, and the properties such as ion conductivity can be made excellent.

Examples of the lithium compound contained in the second particles P2 include inorganic salts such as LiH, LiF, LiCl, LiBr, LiI, LiClO, LiClO₄, LiNO₃, LiNO₂, Li₃N, LiN₃, LiNH₂, Li₂SO₄, Li₂S, LiOH, and Li₂CO₃, carboxylates such as lithium formate, lithium acetate, lithium propionate, lithium 2-ethylhexanoate, and lithium stearate, hydroxy acid salts such as lithium lactate, lithium malate, and lithium citrate, dicarboxylates such as lithium oxalate, lithium malonate, and lithium maleate, alkoxides such as lithium methoxide, lithium ethoxide, and lithium isopropoxide, alkylated lithium such as methyl lithium and n-butyl lithium, sulfate esters such as lithium n-butyl sulfate, lithium n-hexyl sulfate, and lithium dodecyl sulfate, diketone complexes such as 2,4-pentanedionato lithium, and hydrates thereof, and derivatives thereof such as a halogen-substituted substance, and one type or a combination of two or more types selected from these can be used.

Above all, the lithium compound is preferably one type or two types selected from the group consisting of Li₂CO₃ and LiNO₃.

According to this, the above-mentioned effect is more remarkably exhibited.

The content of the lithium compound in the second particles P2 is not particularly limited, but is preferably 10 mass % or more and 20 mass % or less, more preferably 12 mass % or more and 18 mass % or less, and further more preferably 15 mass % or more and 17 mass % or less.

According to this, even when a heat treatment for the solid composition P100 is performed at a lower temperature for a shorter time, the solid electrolyte molded body having a particularly excellent ion conduction property can be favorably obtained.

In the plurality of second particles P2 constituting the solid composition P100, the contents of the lithium compound may be different. In such a case, as the value of the content of the lithium compound in the second particles P2, the average value of the contents of the lithium compound in the plurality of second particles P2 constituting the solid composition P100 shall be adopted. In other words, the ratio of the total mass of the lithium compound constituting the second particles P2 to the mass of the assembly of all the second particles P2 constituting the solid composition P100 shall be adopted.

Further, the solid composition P100 may contain multiple types of lithium compounds. In that case, multiple types of lithium compounds may be contained in a single second particle P2, or the solid composition P100 may contain different types of lithium compounds to be contained as multiples types of second particles P2.

When the content of the precursor oxide in the solid composition P100 is represented by XP [mass %] and the content of the lithium compound in the solid composition P100 is represented by XL [mass %], it is preferred to satisfy a relationship: 0.13≤ XL/XP≤ 0.58, it is more preferred to satisfy a relationship: 0.15≤ XL/XP≤ 0.4, and it is further more preferred to satisfy a relationship: 0.18≤ XL/XP≤ 0.3.

According to this, even when a heat treatment for the solid composition P100 is performed at a lower temperature for a shorter time, the solid electrolyte molded body having a particularly excellent ion conduction property can be favorably obtained.

However, in this specification, in the “lithium compound”, a lithium compound as the constituent component of the first solid electrolyte shall not be included unless otherwise stated. In particular, in this embodiment, as the value of the content XL (mass %) of the lithium compound, the content of the precursor oxide in the second particles P2 can be adopted.

### [1-2-3] Oxoacid Compound

The second particles P2 contain an oxoacid compound.

By containing the oxoacid compound in this manner, the melting point of the precursor oxide is favorably lowered, and the crystal growth of the lithium-containing composite oxide can be promoted, and by a heat treatment at a relatively low temperature for a relatively short time, the solid electrolyte molded body that has a low solid electrolyte grain boundary resistance and an excellent ion conductivity and that is constituted by a solid electrolyte having a high denseness can be favorably formed.

The oxoacid compound is a compound containing an oxoanion.

The oxoanion constituting the oxoacid compound does not contain a metal element, and for example, a halogen oxoacid, a borate ion, a carbonate ion, an orthocarbonate ion, a carboxylate ion, a silicate ion, a nitrite ion, a nitrate ion, a phosphite ion, a phosphate ion, an arsenate ion, a sulfite ion, a sulfate ion, a sulfonate ion, a sulfinate ion, and the like are exemplified. As the halogen oxoacid, for example, a hypochlorous ion, a chlorite ion, a chlorate ion, a perchlorate ion, a hypobromite ion, a bromite ion, a bromate ion, a perbromate ion, a hypoiodite ion, an iodite ion, an iodate ion, a periodate ion, and the like are exemplified.

In particular, the oxoacid compound preferably contains, as the oxoanion, at least one of a nitrate ion and a sulfate ion, and more preferably contains a nitrate ion.

According to this, the melting point of the precursor oxide is more favorably lowered, and the crystal growth of the lithium-containing composite oxide can be more effectively promoted. As a result, even when the heat treatment for the solid composition P100 is performed at a lower temperature for a shorter time, the solid electrolyte molded body having a particularly excellent ion conduction property can be favorably obtained.

A cation constituting the oxoacid compound is not particularly limited, and examples thereof include a hydrogen ion, an ammonium ion, a lithium ion, a lanthanum ion, a zirconium ion, a niobium ion, a tantalum ion, and antimony ion, and one type or a combination of two or more types selected from these can be used. However, it is preferably an ion of a constituent metal element of the second solid electrolyte to be formed from the second particles P2.

According to this, an undesirable impurity can be more effectively prevented from remaining in the second solid electrolyte to be formed.

When the oxoacid compound is a compound containing a lithium ion together with an oxoanion, it can be said that the compound is an oxoacid compound and also is a lithium compound.

The content of the oxoacid compound in the second particles P2 is not particularly limited, but is preferably 0.1 mass % or more and 20 mass % or less, more preferably 1.5 mass % or more and 15 mass % or less, and further more preferably 2.0 mass % or more and 10 mass % or less.

According to this, while more reliably preventing the oxoacid compound from undesirably remaining in the solid electrolyte molded body to be formed using the solid composition P100, the solid electrolyte molded body having a particularly excellent ion conduction property can be favorably obtained even when the heat treatment for the solid composition P100 is performed at a lower temperature for a shorter time.

In the plurality of second particles P2 constituting the solid composition P100, the contents of the oxoacid compound may be different. In such a case, as the value of the content of the oxoacid compound in the second particles P2, the average value of the contents of the oxoacid compound in the plurality of second particles P2 constituting the solid composition P100 shall be adopted. In other words, the ratio of the total mass of the oxoacid compound to the mass of the assembly of all the second particles P2 constituting the solid composition P100 shall be adopted.

Further, the solid composition P100 may contain multiple types of oxoacid compounds. In that case, multiple types of oxoacid compounds may be contained in a single second particle P2, or the solid composition P100 may contain different types of oxoacid compounds to be contained as multiples types of second particles P2.

When the content of the precursor oxide in the solid composition P100 is represented by XP [mass %] and the content of the oxoacid compound in the solid composition P100 is represented by XO [mass %], it is preferred to satisfy a relationship: 0.013≤ XO/XP≤ 0.58, it is more preferred to satisfy a relationship: 0.021≤ XO/XP≤ 0.34, and it is further more preferred to satisfy a relationship: 0.02≤ XO/XP≤ 0.19.

According to this, while more reliably preventing the oxoacid compound from undesirably remaining in the solid electrolyte molded body to be formed using the solid composition P100, the solid electrolyte molded body having a particularly excellent ion conduction property can be favorably obtained even when the heat treatment for the solid composition P100 is performed at a lower temperature for a shorter time.

When the content of the lithium compound in the solid composition P100 is represented by XL [mass %] and the content of the oxoacid compound in the solid composition P100 is represented by XO [mass %], it is preferred to satisfy a relationship: 0.05≤ XO/XL≤ 2, it is more preferred to satisfy a relationship: 0.08≤ XO/XL≤ 1.25, and it is further more preferred to satisfy a relationship: 0.11≤ XO/XL≤ 0.67.

According to this, while more reliably preventing the oxoacid compound from undesirably remaining in the solid electrolyte molded body to be formed using the solid composition P100, the solid electrolyte molded body having a particularly excellent ion conduction property can be favorably obtained even when the heat treatment for the solid composition P100 is performed at a lower temperature for a shorter time.

### [1-2-4] Another Component

The second particles P2 contain the precursor oxide, the lithium compound, and the oxoacid compound as described above, but may further contain a component other than these. Hereinafter, among the components constituting the second particles P2, a component other than the precursor oxide, the lithium compound, and the oxoacid compound is referred to as “another component”.

As such another component contained in the second particles P2, for example, the first solid electrolyte, the second solid electrolyte, a solvent component used in the process for producing the solid composition P100, or the like is exemplified.

The content of such another component in the second particles P2 is not particularly limited, but is preferably 10 mass % or less, more preferably 5.0 mass % or less, further more preferably 0.5 mass % or less.

### [1-2-5] Overall Configuration of Second Particles

The average particle diameter of the second particles P2 is not particularly limited, but is preferably 0.1 μm or more and 20 μm or less, more preferably 1 μm or more and 10 μm or less, and further more preferably 3 μm or more and 5 μm or less.

According to this, the fluidity and ease of handling of the solid composition P100 can be made more favorable. Further, in the solid electrolyte molded body to be produced using the solid composition P100, the first solid electrolyte and the second solid electrolyte can be distributed in a more favorable form, and the solid electrolyte grain boundary resistance in the solid electrolyte molded body can be further decreased, so that the ion conductivity and denseness can be further increased. Further, this is also advantageous from the viewpoint of improvement of the productivity of the solid composition P100 and reduction of the production cost. In addition, the charge-discharge performance at a high load in a lithium-ion secondary battery to which the solid electrolyte molded body according to the present disclosure is applied can be made more excellent.

When the average particle diameter of the first particles P1 is represented by D1 [μm] and the average particle diameter of the second particles P2 is represented by D2 [μm], it is preferred to satisfy a relationship: 0.1≤ D2/D1≤ 2, it is more preferred to satisfy a relationship: 0.3≤ D2/D1≤ 1, and it is further more preferred to satisfy a relationship: 0.5≤ D2/D1≤ 0.7.

According to this, in the solid composition P100, the occurrence of undesirable unevenness in the distribution of the first particles P1 and the second particles P2 can be more effectively prevented. As a result, undesirable unevenness in the formulation at the respective sites of the solid electrolyte molded body to be produced using the solid composition P100 or the like can be more effectively prevented, and the denseness of the solid electrolyte molded body can be further increased. In addition, the fluidity and ease of handling of the solid composition P100 can be made more favorable. Further, in the solid electrolyte molded body to be produced using the solid composition P100, the first solid electrolyte and the second solid electrolyte can be distributed in a more favorable form, and the solid electrolyte grain boundary resistance in the solid electrolyte molded body can be further decreased, so that the ion conductivity and denseness can be further increased.

In the drawing, the second particle P2 has a perfect spherical shape, but the shape of the second particle P2 is not limited thereto.

The solid composition P100 generally includes a plurality of second particles P2, but may include, for example, the second particles P2 having mutually different conditions. For example, the solid composition P100 may include the second particles P2 in which at least one of the particle diameter, shape, and formulation is different.

The content of the second particles P2 in the solid composition P100 is preferably 2 mass % or more and 55 mass % or less, more preferably 10 mass % or more and 45 mass % or less, and further more preferably 25 mass % or more and 35 mass % or less.

According to this, the ratio of the first particles P1 to the second particles P2 in the solid composition P100 is easily adjusted within a favorable range, and the solid electrolyte molded body to be produced using the solid composition P100 can be made to have a lower solid electrolyte grain boundary resistance, a more excellent ion conductivity, and a higher denseness. Further, the charge-discharge performance at a high load in a lithium-ion secondary battery to which the solid composition P100 is applied can be made more excellent.

When the content of the first particles P1 in the solid composition P100 is represented by X1 [mass %] and the content of the second particles P2 in the solid composition P100 is represented by X2 [mass %], it is preferred to satisfy a relationship: 0.05≤ X2/X1≤ 1.20, it is more preferred to satisfy a relationship: 0.10≤ X2/X1≤ 1.00, and it is further more preferred to satisfy a relationship: 0.20≤ X2/X1≤ 0.70.

According to this, the solid electrolyte molded body to be produced using the solid composition P100 can be made to have a lower solid electrolyte grain boundary resistance, a more excellent ion conductivity, and a higher denseness. Further, the charge-discharge performance at a high load in a lithium-ion secondary battery to which the solid composition P100 is applied can be made more excellent.

When M is at least one type of element selected from the group consisting of Nb, Ta, and Sb, it is preferred that the second particles P2 contain Li, La, Zr, and M. In particular, it is preferred that the ratio of substance amounts of Li, La, Zr, and M contained in the second particles P2 is 7−x:3:2−x:x, and a relationship: 0<x<2.0 is satisfied.

According to this, the ion conduction property of the second solid electrolyte to be formed using the second particles P2 can be made more excellent, and also the ion conduction property of the solid electrolyte molded body as a whole to be produced using the solid composition P100 can be made more excellent.

Here, x satisfies a condition: 0<x<2.0, but preferably satisfies a condition: 0.01<x<1.75, more preferably satisfies a condition: 0.1<x<1.25, and further more preferably satisfies a condition: 0.2<x<1.0.

According to this, the above-mentioned effect is more remarkably exhibited.

### [1-3] Another Configuration

The solid composition P100 may further has another configuration in addition to the first particles P1 and the second particles P2. Examples of such a configuration include particles constituted by a material that contains the precursor oxide but does not contain the oxoacid compound, particles constituted by a material that contains the oxoacid compound but does not contain the precursor oxide, and particles constituted by the second solid electrolyte.

However, the proportion of the configuration other than the first particles P1 and the second particles P2 in the solid composition P100 is preferably 20 mass % or less, more preferably 10 mass % or less, and further more preferably 5.0 mass % or less.

Further, the solid composition P100 may include an aggregate in which the first particles P1 and the second particles P2 are aggregated.

### [2] Method for Producing Solid Composition

Next, a method for producing the above-mentioned solid composition will be described.

The solid composition according to the present disclosure can be produced, for example, as follows.

That is, the solid composition P100 according to the present disclosure can be favorably produced by mixing the first particles P1 and the second particles P2.

### [2-1] Production of First Particles

The first particles P1 can be obtained by, for example, preparing multiple types of metal compounds corresponding to the respective metal elements constituting the first solid electrolyte, mixing these at a ratio corresponding to the constituent metal elements of the first solid electrolyte, and firing the resulting mixture at a high temperature.

The metal elements constituting the metal compounds vary depending on the first solid electrolyte to be produced.

As the metal compound, for example, a metal oxide, a metal salt, or the like can be used.

The firing temperature of the mixture is not particularly limited, but can be set to, for example, 1100° C. or higher and 1500° C. or lower.

The first solid electrolyte obtained by firing may be subjected to a treatment such as grinding or classification as needed.

The first particles P1 can be obtained by, for example, subjecting a composition containing a precursor oxide and an oxoacid compound obtained in the same manner as described in the method for producing the second particles P2 which will be described later to a firing treatment.

In that case, the heating temperature in the firing treatment is preferably 700° C. or higher and 1000° C. or lower, more preferably 730° C. or higher and 980° C. or lower, further more preferably 750° C. or higher and 950° C. or lower, and most preferably 780° C. or higher and 930° C. or lower.

### [2-2] Production of Second Particles

The second particles P2 can be produced, for example, as follows.

### [2-2-1] Preparation of Mixed Liquid

First, a mixed liquid containing a metal compound including a metal element constituting the precursor oxide in a molecule, a lithium compound, and a solvent is prepared.

This mixed liquid can be obtained by, for example, preparing a solution containing a metal compound including a metal element constituting the precursor oxide in a molecule and a solvent, and a solution containing a lithium compound, and mixing these solutions at a ratio stoichiometrically corresponding to the formulation of a solid electrolyte to be finally formed. Note that in place of the solution, a dispersion liquid may be used.

As the solution containing a metal compound including a metal element constituting the precursor oxide in a molecule and a solvent, multiple types of solutions may be used. More specifically, for example, multiple types of solutions separately containing multiple types of metal elements constituting the precursor oxide may be used. Further more specifically, for example, when the precursor oxide contains La, Zr, and the above M as the metal elements, in the preparation of the mixed liquid, a solution containing La, a solution containing Zr, and a solution containing M may be used.

Further, as the solution containing a lithium compound, multiple types of solutions may be used. More specifically, for example, as the solution containing a lithium compound, a solution containing a first lithium compound, and a solution containing a second lithium compound that is different from the first lithium compound may be used.

Further, in the preparation of the mixed liquid, for example, the oxoacid compound may be used in addition to the metal compound and the lithium compound. Further, by using a compound containing an oxoanion corresponding to the oxoacid compound as the metal compound, or by using a compound containing an oxoanion corresponding to the oxoacid compound as the lithium compound, it is not necessary to separately use an oxoacid compound different from the metal compound or the lithium compound in addition to such a compound.

The oxoacid compound may be added during or after the below-mentioned first heat treatment or during or after the below-mentioned second heat treatment, however, a case where at least one of the metal compound and the lithium compound to be used in the preparation of the mixed liquid contains an oxoanion corresponding to the oxoacid compound will be mainly described.

As the metal compound containing a metal element constituting the precursor oxide in a molecule, for example, compounds as follows can be used.

That is, as a lanthanum compound that is a metal compound as a lanthanum source, for example, a lanthanum metal salt, a lanthanum alkoxide, lanthanum hydroxide, and the like are exemplified, and among these, one type or two or more types in combination can be used. Examples of the lanthanum metal salt include lanthanum chloride, lanthanum nitrate, lanthanum sulfate, lanthanum acetate, and tris(2,4-pentanedionato)lanthanum. Examples of the lanthanum alkoxide include lanthanum trimethoxide, lanthanum triethoxide, lanthanum tripropoxide, lanthanum triisopropoxide, lanthanum tri-n-butoxide, lanthanum triisobutoxide, lanthanum tri-sec-butoxide, lanthanum tri-tert-butoxide, and dipivaloylmethanato lanthanum. Above all, the lanthanum compound is preferably at least one type selected from the group consisting of lanthanum nitrate, tris(2,4-pentanedionato)lanthanum, and lanthanum hydroxide. As the lanthanum source, a hydrate may be used.

As a zirconium compound that is a metal compound as a zirconium source, for example, a zirconium metal salt, a zirconium alkoxide, and the like are exemplified, and among these, one type or two or more types in combination can be used. Examples of the zirconium metal salt include zirconium chloride, zirconium oxychloride, zirconium oxynitrate, zirconium oxysulfate, zirconium oxyacetate, and zirconium acetate. Examples of the zirconium alkoxide include zirconium tetramethoxide, zirconium tetraethoxide, zirconium tetrapropoxide, zirconium tetraisopropoxide, zirconium tetra-n-butoxide, zirconium tetraisobutoxide, zirconium tetra-sec-butoxide, zirconium tetra-tert-butoxide, and dipivaloylmethanato zirconium. Above all, as the zirconium compound, zirconium tetra-n-butoxide is preferred. As the zirconium source, a hydrate may be used.

As a niobium compound that is a metal compound as a niobium source, for example, a niobium metal salt, a niobium alkoxide, niobium acetylacetone, and the like are exemplified, and among these, one type or two or more types in combination can be used. Examples of the niobium metal salt include niobium chloride, niobium oxychloride, and niobium oxalate. Examples of the niobium alkoxide include niobium ethoxide such as niobium pentaethoxide, niobium propoxide, niobium isopropoxide, and niobium sec-butoxide. Above all, as the niobium compound, niobium pentaethoxide is preferred. As the niobium source, a hydrate may be used.

As a tantalum compound that is a metal compound as a tantalum source, for example, a tantalum metal salt, a tantalum alkoxide, and the like are exemplified, and among these, one type or two or more types in combination can be used. Examples of the tantalum metal salt include tantalum chloride and tantalum bromide. Examples of the tantalum alkoxide include tantalum pentamethoxide, tantalum pentaethoxide, tantalum pentaisopropoxide, tantalum penta-n-propoxide, tantalum pentaisobutoxide, tantalum penta-n-butoxide, tantalum penta-sec-butoxide, and tantalum penta-tert-butoxide. Above all, as the tantalum compound, tantalum pentaethoxide is preferred. As the tantalum source, a hydrate may be used.

As an antimony compound that is a metal compound as an antimony source, for example, an antimony metal salt, an antimony alkoxide, and the like are exemplified, and among these, one type or two or more types in combination can be used. Examples of the antimony metal salt include antimony bromide, antimony chloride, and antimony fluoride. Examples of the antimony alkoxide include antimony trimethoxide, antimony triethoxide, antimony triisopropoxide, antimony tri-n-propoxide, antimony triisobutoxide, and antimony tri-n-butoxide. Above all, as the antimony compound, antimony tri-n-butoxide is preferred. As the antimony source, a hydrate may be used.

As a lithium compound, for example, a lithium metal salt, a lithium alkoxide, and the like are exemplified, and among these, one type or two or more types in combination can be used. Examples of the lithium metal salt include lithium chloride, lithium nitrate, lithium sulfate, lithium acetate, lithium hydroxide, lithium carbonate, and (2,4-pentanedionato)lithium. Examples of the lithium alkoxide include lithium methoxide, lithium ethoxide, lithium propoxide, lithium isopropoxide, lithium n-butoxide, lithium isobutoxide, lithium sec-butoxide, lithium tert-butoxide, and dipivaloylmethanato lithium. Above all, the lithium compound is preferably one type or two or more types selected from the group consisting of lithium nitrate, lithium sulfate, and (2,4-pentanedionato)lithium. As the lithium source, a hydrate may be used.

The solvent is not particularly limited, and for example, various types of organic solvents can be used, however, more specifically, for example, an alcohol, a glycol, a ketone, an ester, an ether, an organic acid, an aromatic, an amide, and the like are exemplified, and one type or a mixed solvent that is a combination of two or more types selected from these can be used. Examples of the alcohol include methyl alcohol, ethyl alcohol, n-propyl alcohol, isopropyl alcohol, n-butyl alcohol, allyl alcohol, and 2-n-butoxyethanol. Examples of the glycol include ethylene glycol, propylene glycol, butylene glycol, hexylene glycol, pentanediol, hexanediol, heptanediol, and dipropylene glycol. Examples of the ketone include dimethyl ketone, methyl ethyl ketone, methyl propyl ketone, and methyl isobutyl ketone. Examples of the ester include methyl formate, ethyl formate, methyl acetate, and methyl acetoacetate. Examples of the ether include diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether. Examples of the organic acid include formic acid, acetic acid, 2-ethylbutyric acid, and propionic acid. Examples of the aromatic include toluene, o-xylene, and p-xylene. Examples of the amide include formamide, N,N-dimethylformamide, N,N-diethylformamide, dimethylacetamide, and N-methylpyrrolidone. Above all, the solvent is preferably at least one of 2-n-butoxyethanol and propionic acid.

At least one of the metal compound and the lithium compound to be used in the preparation of the mixed liquid may contain an oxoanion corresponding to the oxoacid compound, but in that case, it is preferred that the oxoanion forms a salt with at least one of a lithium ion and a lanthanum ion.

According to this, an oxidation reaction when forming a composite oxide is promoted, and it becomes easy to form the composite oxide into nanoparticles at a lower temperature.

### [2-2-2] First Heat Treatment

The mixed liquid prepared as described above is subjected to a first heat treatment. By doing this, the mixed liquid is generally gelled.

The conditions of the first heat treatment depend on the boiling point or the vapor pressure of the solvent or the like, but the heating temperature in the first heat treatment is preferably 50° C. or higher and 250° C. or lower, more preferably 60° C. or higher and 230° C. or lower, and further more preferably 80° C. or higher and 200° C. or lower. During the first heat treatment, the heating temperature may be changed. For example, the first heat treatment may include a first stage in which a heat treatment is performed while maintaining a relatively low temperature, and a second stage in which the temperature is raised after the first stage and a heat treatment at a relatively high temperature is performed. In such a case, it is preferred that the highest temperature in the first heat treatment falls within the above-mentioned range.

Further, the heating time in the first heat treatment is preferably 10 minutes or more and 180 minutes or less, more preferably 20 minutes or more and 120 minutes or less, and further more preferably 30 minutes or more and 60 minutes or less.

The first heat treatment may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, the first heat treatment may be performed under reduced pressure or vacuum, or under pressure.

Further, during the first heat treatment, the atmosphere may be maintained under substantially the same conditions, or may be changed to different conditions. For example, the first heat treatment may include a first stage in which a heat treatment is performed in a normal pressure environment and a second stage in which a heat treatment is performed in a reduced pressure environment after the first stage.

### [2-2-3] Second Heat Treatment

Thereafter, the mixture obtained by the first heat treatment, that is, the mixture in a gel form is subjected to a second heat treatment.

By doing this, the second particles P2 containing the precursor oxide, the lithium compound, and the oxoacid compound, or a composition having the same formulation as the second particles P2 are/is obtained.

Although the conditions of the second heat treatment depend on the formulation of the precursor oxide to be formed or the like, the heating temperature in the second heat treatment is preferably 400° C. or higher and 600° C. or lower, more preferably 430° C. or higher and 570° C. or lower, and further more preferably 450° C. or higher and 550° C. or lower. During the second heat treatment, the heating temperature may be changed. For example, the second heat treatment may include a first stage in which a heat treatment is performed while maintaining a relatively low temperature, and a second stage in which the temperature is raised after the first stage and a heat treatment is performed at a relatively high temperature. In such a case, it is preferred that the highest temperature in the second heat treatment falls within the above-mentioned range.

Further, the heating time in the second heat treatment is preferably 5 minutes or more and 180 minutes or less, more preferably 10 minutes or more and 120 minutes or less, and further more preferably 15 minutes or more and 60 minutes or less.

The second heat treatment may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, the second heat treatment may be performed under reduced pressure or vacuum, or under pressure. In particular, the second heat treatment is preferably performed in an oxidizing atmosphere.

Further, during the second heat treatment, the atmosphere may be maintained under substantially the same conditions, or may be changed to different conditions. For example, the second heat treatment may include a first stage in which a heat treatment is performed in an inert gas atmosphere and a second stage in which a heat treatment is performed in an oxidizing atmosphere after the first stage.

The second particles P2 or the composition having the same formulation as the second particles P2 obtained as described above may be subjected to, for example, a grinding treatment so as to adjust the particle diameters of the second particles P2.

In the second particles P2 obtained as described above, generally, almost all the solvent used in the production process has been removed, however, a portion of the solvent may remain therein. However, the content of the solvent in the second particles P2 is preferably 1.0 mass % or less, and more preferably 0.1 mass % or less.

The second particles P2 obtained as described above are converted into the second solid electrolyte by heating as described in detail later, particularly, by heating at a higher temperature than in the above-mentioned second heat treatment.

Therefore, when the heat treatment for obtaining the second solid electrolyte from the second particles P2 is regarded as main firing, the above-mentioned second heat treatment can be referred to as calcination. Further, when the second solid electrolyte obtained by the heat treatment which will be described in detail later is regarded as a main fired body, the second particles P2 obtained through the second heat treatment described above can be referred to as a calcined body.

### [2-3] Mixing of First Particles and Second Particles

Thereafter, by mixing the first particles P1 and the second particles P2 obtained as described above, the solid composition P100 is obtained.

A method for mixing the first particles P1 and the second particles P2 is not particularly limited, and may be, for example, wet mixing, but is preferably dry mixing.

### [3] Method for Producing Solid Electrolyte Molded Body

Next, a method for producing a solid electrolyte molded body according to the present disclosure will be described.

The method for producing a solid electrolyte molded body according to the present disclosure includes a molding step of obtaining a molded body using the solid composition according to the present disclosure described above, and a heat treatment step of subjecting the obtained molded body to a heat treatment so as to react the precursor oxide, the oxoacid compound, and the lithium compound in the solid composition to cause conversion to the second solid electrolyte, thereby forming a solid electrolyte molded body containing the first solid electrolyte and the second solid electrolyte.

According to this, a method for producing a solid electrolyte molded body that has a low solid electrolyte grain boundary resistance and an excellent ion conductivity and that is constituted by a solid electrolyte having a high denseness can be provided.

### [3-1] Molding Step

In the molding step, a molded body is obtained using the solid composition P100 according to the present disclosure described above.

In this step, the solid composition P100 itself may be molded, or a mixture of the solid composition P100 with another component may be molded.

As such another component, for example, a dispersion medium for dispersing the constituent particles of the solid composition P100, that is, the first particles P1 or the second particles P2, a positive electrode active material, a negative electrode active material, a binder, and the like are exemplified. Such a component can be used, for example, in the production of a molded body in a state of being mixed with the solid composition P100.

In particular, when a positive electrode composite material as described in detail later is produced as the solid electrolyte molded body, it is preferred to use a positive electrode active material in combination with the solid composition P100. Further, when a negative electrode composite material as described in detail later is produced as the solid electrolyte molded body, it is preferred to use a negative electrode active material in combination with the solid composition P100.

Further, by using a dispersion medium, for example, a composition to be used in the production of the molded body, that is, a composition containing the solid composition P100 can be formed into a paste or the like, so that the fluidity and ease of handling of the composition are improved, and the moldability of the molded body is improved.

However, the content of such another component in the composition to be used in the production of the molded body is preferably 20 mass % or less, more preferably 10 mass % or less, and further more preferably 5 mass % or less.

After obtaining the molded body using the solid composition P100, another component may be added to the molded body for the purpose of improving the stability of the shape of the molded body or the performance of the solid electrolyte molded body to be produced using the method according to the present disclosure, or the like.

Further, in the molding step, multiple types of solid compositions P100 according to the present disclosure may be combined and used. For example, multiple types of solid compositions P100, in which the conditions of the first particles P1, the second particles P2, or the like, or the blending ratios thereof are different may be mixed and used.

As the molding method for obtaining the molded body, various molding methods can be adopted, and for example, compression molding, extrusion molding, injection molding, various printing methods, various coating methods, and the like are exemplified.

The shape of the molded body obtained in this step is not particularly limited, but generally corresponds to the shape of the target solid electrolyte molded body. Note that the molded body obtained in this step may have a different shape or size from that of the target solid electrolyte molded body in consideration of a portion to be removed in the later step or a shrinkage or the like in the heat treatment step.

### [3-2] Heat Treatment Step

In the heat treatment step, a heat treatment is performed for the molded body obtained in the molding step. By doing this, the constituent materials of the second particles P2 are converted into the second solid electrolyte, whereby the solid electrolyte molded body containing the first solid electrolyte and the second solid electrolyte is obtained.

The solid electrolyte molded body obtained in this manner has excellent adhesion between the first solid electrolyte and the second solid electrolyte, or the like, and an undesirable void can be effectively prevented from occurring therebetween. Therefore, the solid electrolyte molded body to be obtained has a low solid electrolyte grain boundary resistance and an excellent ion conductivity and is constituted by a solid electrolyte having a high denseness.

The heating temperature of the molded body in the heat treatment step is not particularly limited, but is preferably 700° C. or higher and 1000° C. or lower, more preferably 730° C. or higher and 980° C. or lower, and further more preferably 750° C. or higher and 950° C. or lower.

By performing heating at such a temperature, undesirable volatilization of a constituent component of the solid composition P100, particularly, a component having relatively high volatility such as Li during heating can be more reliably prevented while making the denseness of the solid electrolyte molded body to be obtained sufficiently high, and the solid electrolyte molded body having a desired formulation can be more reliably obtained. Further, since the heating treatment is performed at a relatively low temperature, this is also advantageous from the viewpoint of energy saving, improvement of the productivity of the solid electrolyte molded body, or the like.

In this step, the heating temperature may be changed. For example, this step may include a first stage in which a heat treatment is performed while maintaining a relatively low temperature, and a second stage in which the temperature is raised after the first stage and a heat treatment at a relatively high temperature is performed. In such a case, it is preferred that the highest temperature in this step falls within the above-mentioned range.

The heating time in this step is not particularly limited, but is preferably 5 minutes or more and 300 minutes or less, more preferably 10 minutes or more and 120 minutes or less, and further more preferably 15 minutes or more and 60 minutes or less.

According to this, the above-mentioned effect is more remarkably exhibited.

This step may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, this step may be performed under reduced pressure or vacuum, or under pressure. In particular, this step is preferably performed in an oxidizing atmosphere.

Further, during this step, the atmosphere may be maintained under substantially the same conditions, or may be changed to different conditions.

The solid electrolyte molded body obtained using the method for producing a solid electrolyte molded body according to the present disclosure generally does not substantially contain the oxoacid compound contained in the solid composition P100 used as a raw material. More specifically, the content of the oxoacid compound in the solid electrolyte molded body obtained using the method for producing a solid electrolyte molded body according to the present disclosure is generally 100 ppm or less, and particularly, it is preferably 50 ppm or less, and more preferably 10 ppm or less.

According to this, the content of an undesirable impurity in the solid electrolyte molded body can be suppressed, and the properties and reliability of the solid electrolyte molded body can be made more excellent.

The second solid electrolyte formed in this step need only be different from the precursor oxide or the oxoacid compound that are the raw materials thereof, and may be different from the first solid electrolyte or may be substantially the same as the first solid electrolyte.

When the first solid electrolyte and the second solid electrolyte are substantially the same, the adhesion between the first solid electrolyte and the second solid electrolyte in the solid electrolyte molded body can be improved, and the mechanical strength and the stability of the shape of the solid electrolyte molded body, and the stability of the property and reliability of the solid electrolyte molded body, and the like can be made more excellent.

Here, the phrase “substantially the same” means that the formulation can be regarded as the same.

### [4] Lithium-Ion Secondary Battery

Next, a lithium-ion secondary battery to which the present disclosure is applied will be described.

A lithium-ion secondary battery according to the present disclosure is produced using the solid composition according to the present disclosure as described above, and can be produced by, for example, applying the method for producing a solid electrolyte molded body according to the present disclosure described above.

Such a lithium-ion secondary battery has a low solid electrolyte grain boundary resistance, an excellent ion conductivity, and excellent charge-discharge characteristics.

### [4-1] Lithium-Ion Secondary Battery of First Embodiment

Hereinafter, a lithium-ion secondary battery according to a first embodiment will be described.

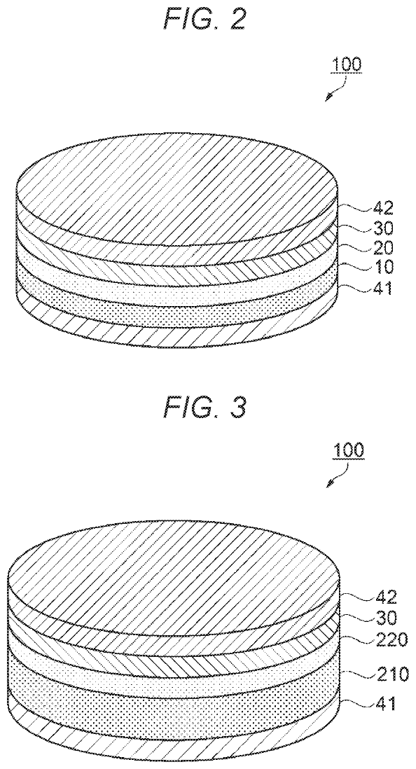

FIG. 2 is a schematic perspective view schematically showing a configuration of the lithium-ion secondary battery of the first embodiment.

As shown in FIG. 2, a lithium-ion secondary battery 100 includes a positive electrode 10, and a solid electrolyte layer 20 and a negative electrode 30, which are sequentially stacked on the positive electrode 10. The lithium-ion secondary battery further includes a current collector 41 in contact with the positive electrode 10 at an opposite face side of the positive electrode 10 from a face thereof facing the solid electrolyte layer 20, and includes a current collector 42 in contact with the negative electrode 30 at an opposite face side of the negative electrode 30 from a face thereof facing the solid electrolyte layer 20. The positive electrode 10, the solid electrolyte layer 20, and the negative electrode 30 are all constituted by a solid phase, and therefore, the lithium-ion secondary battery 100 is a chargeable and dischargeable all-solid-state battery.

The shape of the lithium-ion secondary battery 100 is not particularly limited, and may be, for example, a polygonal disk shape or the like, but is a circular disk shape in the configuration shown in the drawing. The size of the lithium-ion secondary battery 100 is not particularly limited, but for example, the diameter of the lithium-ion secondary battery 100 is, for example, 10 mm or more and 20 mm or less, and the thickness of the lithium-ion secondary battery 100 is, for example, 0.1 mm or more and 1.0 mm or less.

When the lithium-ion secondary battery 100 is small and thin in this manner, together with the fact that it is chargeable and dischargeable and is an all-solid-state battery, it can be favorably used as a power supply of a portable information terminal such as a smartphone. The lithium-ion secondary battery 100 may be used for a purpose other than the power supply of a portable information terminal as described later.

Hereinafter, the respective configurations of the lithium-ion secondary battery 100 will be described.

### [4-1-1] Solid Electrolyte Layer

The solid electrolyte layer 20 is formed using the solid composition according to the present disclosure described above.

According to this, the ion conductivity of the solid electrolyte layer 20 becomes excellent. Further, the adhesion of the solid electrolyte layer 20 to the positive electrode 10 or the negative electrode 30 can be made excellent. As a result, the properties and reliability of the lithium-ion secondary battery 100 as a whole can be made particularly excellent.

The thickness of the solid electrolyte layer 20 is not particularly limited, but is preferably 1.1 μm or more and 1000 μm or less, and more preferably 2.5 μm or more and 100 μm or less from the viewpoint of charge-discharge rate.

Further, from the viewpoint of preventing a short circuit between the positive electrode 10 and the negative electrode 30 due to a lithium dendritic crystal body deposited at the negative electrode 30 side, a value obtained by dividing the measured weight of the solid electrolyte layer 20 by a value obtained by multiplying the apparent volume of the solid electrolyte layer 20 by the theoretical density of the solid electrolyte material, that is, the sintered density is preferably set to 50% or more, and more preferably set to 90% or more.

As a method for forming the solid electrolyte layer 20, for example, a green sheet method, a press firing method, a cast firing method, or the like is exemplified. A specific example of the method for forming the solid electrolyte layer 20 will be described in detail later. For the purpose of improving the adhesion of the solid electrolyte layer 20 to the positive electrode 10 and the negative electrode 30, or improving the output or battery capacity of the lithium-ion secondary battery 100 by an increase in specific surface area, or the like, for example, a three-dimensional pattern structure such as a dimple, trench, or pillar pattern may be formed at a surface of the solid electrolyte layer 20 that comes in contact with the positive electrode 10 or the negative electrode 30.

### [4-1-2] Positive Electrode

The positive electrode 10 may be any as long as it is constituted by a positive electrode active material that can repeat electrochemical occlusion and release of lithium ions.

Specifically, as the positive electrode active material constituting the positive electrode 10, for example, a lithium composite oxide which contains at least Li and is constituted by any one or more types of elements selected from the group consisting of V, Cr, Mn, Fe, Co, Ni, and Cu, or the like can be used. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂ (PO₄)₃, Li₂CuO₂, Li₂FeSiO₄, and Li₂MnSiO₄. Further, as the positive electrode active material constituting the positive electrode 10, for example, a fluoride such as LiFeF₃, a boride complex compound such as LiBH₄ or Li₄BN₃H₁₀, an iodine complex compound such as a polyvinylpyridine-iodine complex, a nonmetallic compound such as sulfur, or the like can also be used.

The positive electrode 10 is preferably formed as a thin film at one surface of the solid electrolyte layer 20 in consideration of an electric conduction property and an ion diffusion distance.

The thickness of the positive electrode 10 formed of the thin film is not particularly limited, but is preferably 0.1 μm or more and 500 μm or less, and more preferably 0.3 μm or more and 100 μm or less.

As a method for forming the positive electrode 10, for example, a vapor phase deposition method such as a vacuum vapor deposition method, a sputtering method, a CVD method, a PLD method, an ALD method, or an aerosol deposition method, a chemical deposition method using a solution such as a sol-gel method or an MOD method, or the like is exemplified. In addition, for example, fine particles of the positive electrode active material are formed into a slurry together with an appropriate binder, followed by squeegeeing or screen printing, thereby forming a coating film, and then, the coating film may be baked onto the surface of the solid electrolyte layer 20 by drying and firing.

### [4-1-3] Negative Electrode

The negative electrode 30 may be any as long as it is constituted by a so-called negative electrode active material that repeats electrochemical occlusion and release of lithium ions at a lower potential than the material selected as the positive electrode 10.

Specifically, examples of the negative electrode active material constituting the negative electrode 30 include Nb₂O₅, V₂O₅, TiO₂, In₂O₃, ZnO, SnO₂, NiO, ITO, AZO, GZO, ATO, FTO, and lithium composite oxides such as Li₄Ti₅O₁₂ and Li₂Ti₃O₇. Further, additional examples thereof include metals and alloys such as Li, Al, Si, Si—Mn, Si—Co, Si—Ni, Sn, Zn, Sb, Bi, In, and Au, carbon materials, and materials obtained by intercalation of lithium ions between layers of a carbon material such as LiC₂₄ and LiC₆.

The negative electrode 30 is preferably formed as a thin film at one surface of the solid electrolyte layer 20 in consideration of an electric conduction property and an ion diffusion distance.

The thickness of the negative electrode 30 formed of the thin film is not particularly limited, but is preferably 0.1 μm or more and 500 μm or less, and more preferably 0.3 μm or more and 100 μm or less.

As a method for forming the negative electrode 30, for example, a vapor phase deposition method such as a vacuum vapor deposition method, a sputtering method, a CVD method, a PLD method, an ALD method, or an aerosol deposition method, a chemical deposition method using a solution such as a sol-gel method or an MOD method, or the like is exemplified. In addition, for example, fine particles of the negative electrode active material are formed into a slurry together with an appropriate binder, followed by squeegeeing or screen printing, thereby forming a coating film, and then, the coating film may be baked onto the surface of the solid electrolyte layer 20 by drying and firing.

### [4-1-4] Current Collector

The current collectors 41 and 42 are electric conductors provided so as to play a role in transfer of electrons to the positive electrode 10 or the negative electrode 30. As the current collector, generally, a current collector constituted by a material that has a sufficiently small electrical resistance, and that does not substantially change the electric conduction property or the mechanical structure thereof by charging and discharging is used. Specifically, as the constituent material of the current collector 41 of the positive electrode 10, for example, Al, Ti, Pt, Au, or the like is used. Further, as the constituent material of the current collector 42 of the negative electrode 30, for example, Cu or the like is favorably used.

The current collectors 41 and 42 are generally provided so that the contact resistance with the positive electrode 10 and the negative electrode 30 becomes small, respectively. Examples of the shape of each of the current collectors 41 and 42 include a plate shape and a mesh shape.

The thickness of each of the current collectors 41 and 42 is not particularly limited, but is preferably 7 μm or more and 85 μm or less, and more preferably 10 μm or more and 60 μm or less.

In the configuration shown in the drawing, the lithium-ion secondary battery 100 includes a pair of current collectors 41 and 42, however, for example, when a plurality of lithium-ion secondary batteries 100 are used by being stacked and electrically coupled to one another in series, the lithium-ion secondary battery 100 may also be configured to include only the current collector 41 of the current collectors 41 and 42.

The lithium-ion secondary battery 100 may be used for any purpose. Examples of an electronic device to which the lithium-ion secondary battery 100 is applied as a power supply include a personal computer, a digital camera, a cellular phone, a smartphone, a music player, a tablet terminal, a timepiece, a smartwatch, various types of printers such as an inkjet printer, a television, a projector, wearable terminals such as a head-up display, wireless headphones, wireless earphones, smart glasses, and a head-mounted display, a video camera, a videotape recorder, a car navigation device, a drive recorder, a pager, an electronic notebook, an electronic dictionary, an electronic translation machine, an electronic calculator, an electronic gaming device, a toy, a word processor, a work station, a robot, a television telephone, a television monitor for crime prevention, electronic binoculars, a POS (Point of Sales) terminal, a medical device, a fish finder, various types of measurement devices, a device for mobile terminal base stations, various types of meters for vehicles, railroad cars, airplanes, helicopters, ships, or the like, a flight simulator, and a network server. Further, the lithium-ion secondary battery 100 may be applied to, for example, moving objects such as a car and a ship. More specifically, it can be favorably applied as, for example, a storage battery for electric cars, plug-in hybrid cars, hybrid cars, fuel cell cars, or the like. In addition, it can also be applied to, for example, a power supply for household use, a power supply for industrial use, a storage battery for photovoltaic power generation, or the like.

### [4-2] Lithium-Ion Secondary Battery of Second Embodiment

Next, a lithium-ion secondary battery according to a second embodiment will be described.

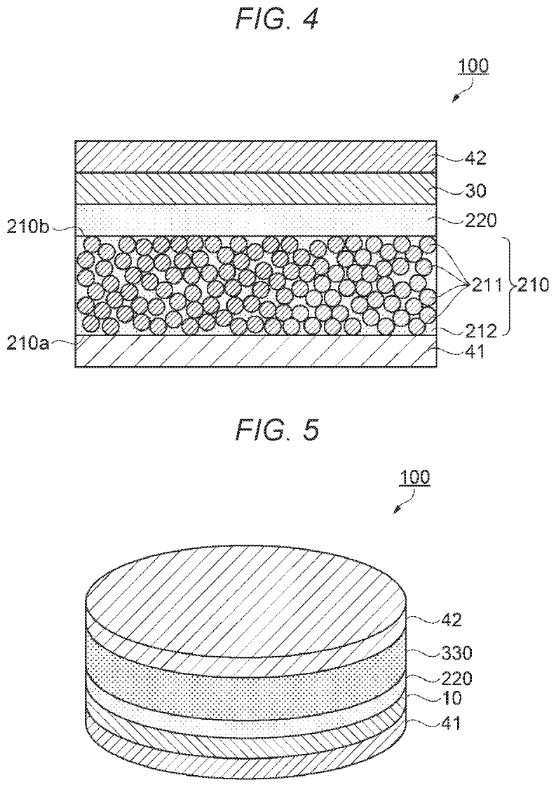

FIG. 3 is a schematic perspective view schematically showing a configuration of the lithium-ion secondary battery of the second embodiment, and FIG. 4 is a schematic cross-sectional view schematically showing a structure of the lithium-ion secondary battery of the second embodiment.

Hereinafter, the lithium-ion secondary battery according to the second embodiment will be described with reference to these drawings, but different points from the above-mentioned embodiment will be mainly described, and the description of the same matter will be omitted.

As shown in FIG. 3, a lithium-ion secondary battery 100 of this embodiment includes a positive electrode composite material 210 that functions as a positive electrode, and an electrolyte layer 220 and a negative electrode 30, which are sequentially stacked on the positive electrode composite material 210. The lithium-ion secondary battery further includes a current collector 41 in contact with the positive electrode composite material 210 at an opposite face side of the positive electrode composite material 210 from a face thereof facing the electrolyte layer 220, and includes a current collector 42 in contact with the negative electrode 30 at an opposite face side of the negative electrode 30 from a face thereof facing the electrolyte layer 220.

Hereinafter, the positive electrode composite material 210 and the electrolyte layer 220 which are different from the configuration of the lithium-ion secondary battery 100 according to the above-mentioned embodiment will be described.

### [4-2-1] Positive Electrode Composite Material

As shown in FIG. 4, the positive electrode composite material 210 in the lithium-ion secondary battery 100 of this embodiment includes a positive electrode active material 211 in a particulate shape and a solid electrolyte 212. In such a positive electrode composite material 210, the battery reaction rate in the lithium-ion secondary battery 100 can be further increased by increasing an interfacial area where the positive electrode active material 211 in a particulate shape and the solid electrolyte 212 are in contact with each other.

The average particle diameter of the positive electrode active material 211 is not particularly limited, but is preferably 0.1 μm or more and 150 μm or less, and more preferably 0.3 μm or more and 60 μm or less.

According to this, it becomes easy to achieve both an actual capacity density close to the theoretical capacity of the positive electrode active material 211 and a high charge-discharge rate.

The particle size distribution of the positive electrode active material 211 is not particularly limited, and for example, in the particle size distribution having one peak, the half width of the peak can be set to 0.15 μm or more and 19 μm or less. Further, the particle size distribution of the positive electrode active material 211 may have two or more peaks.

In FIG. 4, the shape of the positive electrode active material 211 in a particulate shape is shown as a spherical shape, however, the shape of the positive electrode active material 211 is not limited to a spherical shape, and it can have various shapes, for example, a columnar shape, a plate shape, a scaly shape, a hollow shape, an indefinite shape, and the like, and further, two or more types among these may be mixed.

Examples of the positive electrode active material 211 include the same materials as exemplified as the constituent material of the positive electrode 10 in the above-mentioned first embodiment.

In the positive electrode active material 211, for example, a coating layer may be formed at a surface for the purpose of reducing the interface resistance between the positive electrode active material 211 and the solid electrolyte 212, or improving an electron conduction property, or the like. For example, by forming a thin film of LiNbO₃, Al₂O₃, ZrO₂, Ta₂O₅, or the like at a surface of a particle of the positive electrode active material 211 composed of LiCoO₂, the interface resistance of lithium ion conduction can be further reduced. The thickness of the coating layer is not particularly limited, but is preferably 3 nm or more and 1 μm or less.

In this embodiment, the positive electrode composite material 210 includes the solid electrolyte 212 in addition to the positive electrode active material 211 described above. The solid electrolyte 212 is present so as to fill up a gap between particles of the positive electrode active material 211 or so as to be in contact with, particularly in close contact with the surface of the positive electrode active material 211.

The solid electrolyte 212 is formed using the solid composition according to the present disclosure.

According to this, the ion conductivity of the solid electrolyte 212 becomes particularly excellent. Further, the adhesion of the solid electrolyte 212 to the positive electrode active material 211 or the electrolyte layer 220 becomes excellent. Accordingly, the properties and reliability of the lithium-ion secondary battery 100 as a whole can be made particularly excellent.

When the content of the positive electrode active material 211 in the positive electrode composite material 210 is represented by XA [mass %] and the content of the solid electrolyte 212 in the positive electrode composite material 210 is represented by XS [mass %], it is preferred to satisfy a relationship: 0.1≤ XS/XA≤ 8.3, it is more preferred to satisfy a relationship: 0.3≤ XS/XA≤ 2.8, and it is further more preferred to satisfy a relationship: 0.6≤ XS/XA≤ 1.4.

Further, the positive electrode composite material 210 may include an electric conduction assistant, a binder, or the like other than the positive electrode active material 211 and the solid electrolyte 212.

As the electric conduction assistant, any material may be used as long as it is an electric conductor whose electrochemical interaction can be ignored at a positive electrode reaction potential, and more specifically, for example, a carbon material such as acetylene black, Ketjen black, or a carbon nanotube, a noble metal such as palladium or platinum, an electric conductive oxide such as SnO₂, ZnO, RuO₂, ReO₃, or Ir₂O₃, or the like can be used.

The thickness of the positive electrode composite material 210 is not particularly limited, but is preferably 1.1 μm or more and 500 μm or less, and more preferably 2.3 μm or more and 100 μm or less.

### [4-2-2] Electrolyte Layer

The electrolyte layer 220 is preferably constituted by the same material or the same type of material as the solid electrolyte 212 from the viewpoint of an interfacial impedance between the electrolyte layer 220 and the positive electrode composite material 210, but may be constituted by a material different from the solid electrolyte 212. For example, the electrolyte layer 220 is formed using the solid composition according to the present disclosure described above, but may be constituted by a material having a different formulation from the solid electrolyte 212. Further, the electrolyte layer 220 may be a crystalline material or an amorphous material of another oxide solid electrolyte which is not formed using the solid composition according to the present disclosure, a sulfide solid electrolyte, a nitride solid electrolyte, a halide solid electrolyte, a hydride solid electrolyte, a dry polymer electrolyte, or a quasi-solid electrolyte, or may be constituted by a material in which two or more types selected from these are combined.

Examples of a crystalline oxide include Li_{0.35}La_{0.55}TiO₃, Li_{0.2}La_{0.27}NbO₃, and a perovskite-type crystal or a perovskite-like crystal in which the elements constituting a crystal thereof are partially substituted with N, F, Al, Sr, Sc, Nb, Ta, Sb, a lanthanoid element, or the like, Li₇La₃Zr₂O₁₂, Li₅La₃Nb₂O₁₂, Li₅BaLa₂TaO₁₂, and a garnet-type crystal or a garnet-like crystal in which the elements constituting a crystal thereof are partially substituted with N, F, Al, Sr, Sc, Nb, Ta, Sb, a lanthanoid element, or the like, Li_{1.3}Ti_{1.7}Al_{0.3}(PO₄)₃, Li_{1.4}Al_{0.4}Ti_{1.6}(PO₄)₃, Li_{1.4}Al_{0.4}Ti_{1.4}Ge_{0.2}(PO₄)₃, and a NASICON-type crystal in which the elements constituting a crystal thereof are partially substituted with N, F, Al, Sr, Sc, Nb, Ta, Sb, a lanthanoid element, or the like, a LISICON-type crystal such as Li₁₄ZnGe₄O₁₆, and other crystalline materials such as Li_{3.4}V_{0.6}Si_{0.4}O₄, Li_{3.6}V_{0.4}Ge_{0.6}O₄, and Li₂₊ₓC₁₋ₓBₓO₃.

Examples of a crystalline sulfide include Li₁₀GeP₂S₁₂, Li_{9.6}P₃S₁₂, Li_{9.54}Si_{1.74}P_{1.44}S_{11.7}Cl_{0.3}, and Li₃PS₄.

Examples of other amorphous materials include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄Ge O₄—Zn₂GeO₂, Li₄SiO₄—LiMoO₄, Li₄SiO₄—Li₄ZrO₄, SiO₂−P₂O₅−Li₂O, SiO₂—P₂O₅—LiCl, Li₂O—LiCl—B₂O₃, LiAlCl₄, LiAlF₄, LiF—Al₂O₃, LiBr—Al₂O₃, Li_{2.88}PO_{3.73}N_{0.14}, Li₃N—LiCl, Li₆NBr₃, Li₂S—SiS₂, and Li₂S—SiS₂—P₂S₅.

When the electrolyte layer 220 is constituted by a crystalline material, the crystalline material preferably has a crystal structure such as a cubic crystal having small crystal plane anisotropy in the direction of lithium ion conduction. Further, when the electrolyte layer 220 is constituted by an amorphous material, the anisotropy in lithium ion conduction becomes small. Therefore, the crystalline material and the amorphous material as described above are both preferred as a solid electrolyte constituting the electrolyte layer 220.

The thickness of the electrolyte layer 220 is preferably 1.1 μm or more and 100 μm or less, and more preferably 2.5 μm or more and 10 μm or less. When the thickness of the electrolyte layer 220 is a value within the above range, the internal resistance of the electrolyte layer 220 can be further decreased, and also the occurrence of a short circuit between the positive electrode composite material 210 and the negative electrode 30 can be more effectively prevented.

For the purpose of improving the adhesion between the electrolyte layer 220 and the negative electrode 30, or improving the output or battery capacity of the lithium-ion secondary battery 100 by an increase in specific surface area, or the like, for example, a three-dimensional pattern structure such as a dimple, trench, or pillar pattern may be formed at a surface of the electrolyte layer 220 that comes in contact with the negative electrode 30.

### [4-3] Lithium-Ion Secondary Battery of Third Embodiment

Next, a lithium-ion secondary battery according to a third embodiment will be described.

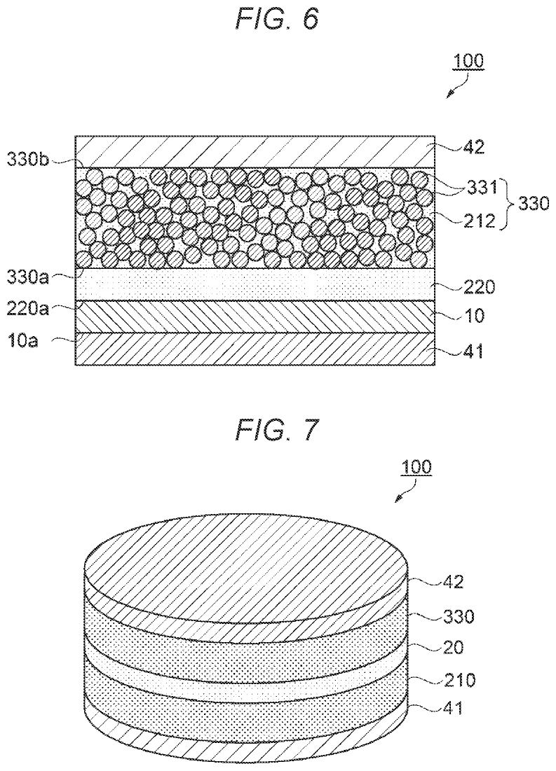

FIG. 5 is a schematic perspective view schematically showing a configuration of the lithium-ion secondary battery of the third embodiment, and FIG. 6 is a schematic cross-sectional view schematically showing a structure of the lithium-ion secondary battery of the third embodiment.

Hereinafter, the lithium-ion secondary battery according to the third embodiment will be described with reference to these drawings, but different points from the above-mentioned embodiments will be mainly described, and the description of the same matter will be omitted.

As shown in FIG. 5, a lithium-ion secondary battery 100 of this embodiment includes a positive electrode 10, and an electrolyte layer 220 and a negative electrode composite material 330 that functions as a negative electrode, which are sequentially stacked on the positive electrode 10. The lithium-ion secondary battery further includes a current collector 41 in contact with the positive electrode 10 at an opposite face side of the positive electrode 10 from a face thereof facing the electrolyte layer 220, and includes a current collector 42 in contact with the negative electrode composite material 330 at an opposite face side of the negative electrode composite material 330 from a face thereof facing the electrolyte layer 220.

Hereinafter, the negative electrode composite material 330 which is different from the configuration of the lithium-ion secondary battery 100 according to the above-mentioned embodiments will be described.

### [4-3-1] Negative Electrode Composite Material

As shown in FIG. 6, the negative electrode composite material 330 in the lithium-ion secondary battery 100 of this embodiment includes a negative electrode active material 331 in a particulate shape and a solid electrolyte 212. In such a negative electrode composite material 330, the battery reaction rate in the lithium-ion secondary battery 100 can be further increased by increasing an interfacial area where the negative electrode active material 331 in a particulate shape and the solid electrolyte 212 are in contact with each other.

The average particle diameter of the negative electrode active material 331 is not particularly limited, but is preferably 0.1 μm or more and 150 μm or less, and more preferably 0.3 μm or more and 60 μm or less.

According to this, it becomes easy to achieve both an actual capacity density close to the theoretical capacity of the negative electrode active material 331 and a high charge-discharge rate.

The particle size distribution of the negative electrode active material 331 is not particularly limited, and for example, in the particle size distribution having one peak, the half width of the peak can be set to 0.1 μm or more and 18 μm or less. Further, the particle size distribution of the negative electrode active material 331 may have two or more peaks.

In FIG. 6, the shape of the negative electrode active material 331 in a particulate shape is shown as a spherical shape, however, the shape of the negative electrode active material 331 is not limited to a spherical shape, and it can have various shapes, for example, a columnar shape, a plate shape, a scaly shape, a hollow shape, an indefinite shape, and the like, and further, two or more types among these may be mixed.

Examples of the negative electrode active material 331 include the same materials as exemplified as the constituent material of the negative electrode 30 in the above-mentioned first embodiment.

In this embodiment, the negative electrode composite material 330 includes the solid electrolyte 212 in addition to the negative electrode active material 331 described above. The solid electrolyte 212 is present so as to fill up a gap between particles of the negative electrode active material 331 or so as to be in contact with, particularly in close contact with the surface of the negative electrode active material 331.

The solid electrolyte 212 is formed using the solid composition according to the present disclosure described above.

According to this, the ion conductivity of the solid electrolyte 212 becomes particularly excellent. Further, the adhesion of the solid electrolyte 212 to the negative electrode active material 331 or the electrolyte layer 220 can be made excellent. Accordingly, the properties and reliability of the lithium-ion secondary battery 100 as a whole can be made particularly excellent.

When the content of the negative electrode active material 331 in the negative electrode composite material 330 is represented by XB [mass %] and the content of the solid electrolyte 212 in the negative electrode composite material 330 is represented by XS [mass %], it is preferred to satisfy a relationship: 0.14≤ XS/XB≤ 26, it is more preferred to satisfy a relationship: 0.44≤ XS/XB≤ 4.1, and it is further more preferred to satisfy a relationship: 0.89≤ XS/XB≤ 2.1.

Further, the negative electrode composite material 330 may include an electric conduction assistant, a binder, or the like other than the negative electrode active material 331 and the solid electrolyte 212.

As the electric conduction assistant, any material may be used as long as it is an electric conductor whose electrochemical interaction can be ignored at a negative electrode reaction potential, and more specifically, for example, a carbon material such as acetylene black, Ketjen black, or a carbon nanotube, a noble metal such as palladium or platinum, an electric conductive oxide such as SnO₂, ZnO, RuO₂, ReO₃, or Ir₂O₃, or the like can be used.

The thickness of the negative electrode composite material 330 is not particularly limited, but is preferably 1.1 μm or more and 500 μm or less, and more preferably 2.3 μm or more and 100 μm or less.

### [4-4] Lithium-Ion Secondary Battery of Fourth Embodiment

Next, a lithium-ion secondary battery according to a fourth embodiment will be described.

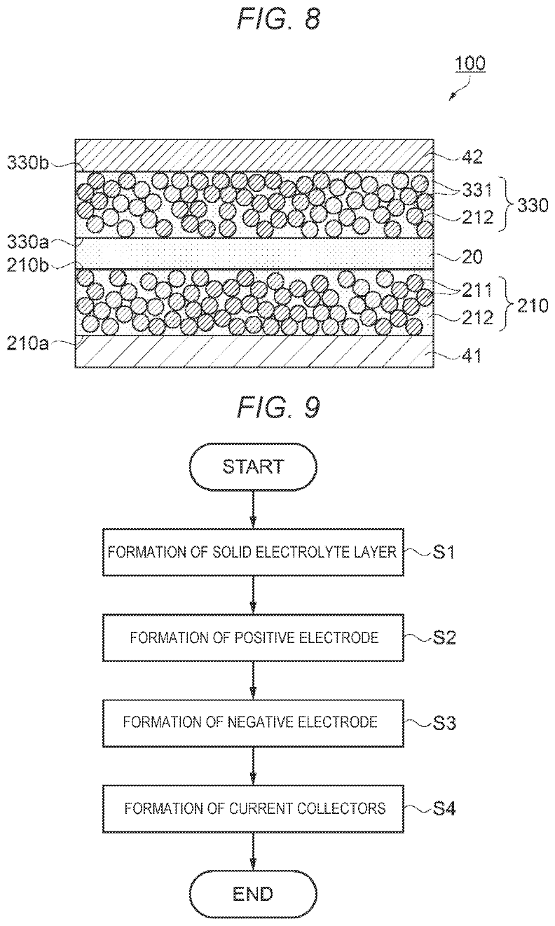

FIG. 7 is a schematic perspective view schematically showing a configuration of the lithium-ion secondary battery of the fourth embodiment, and FIG. 8 is a schematic cross-sectional view schematically showing a structure of the lithium-ion secondary battery of the fourth embodiment.

Hereinafter, the lithium-ion secondary battery according to the fourth embodiment will be described with reference to these drawings, but different points from the above-mentioned embodiments will be mainly described, and the description of the same matter will be omitted.

As shown in FIG. 7, a lithium-ion secondary battery 100 of this embodiment includes a positive electrode composite material 210, and a solid electrolyte layer 20 and a negative electrode composite material 330, which are sequentially stacked on the positive electrode composite material 210. The lithium-ion secondary battery further includes a current collector 41 in contact with the positive electrode composite material 210 at an opposite face side of the positive electrode composite material 210 from a face thereof facing the solid electrolyte layer 20, and includes a current collector 42 in contact with the negative electrode composite material 330 at an opposite face side of the negative electrode composite material 330 from a face thereof facing the solid electrolyte layer 20.

It is preferred that the respective portions satisfy the same conditions as described for the respective corresponding portions in the above-mentioned embodiments.

In the first to fourth embodiments, another layer may be provided between layers or at a surface of a layer of the respective layers constituting the lithium-ion secondary battery 100. Examples of such a layer include an adhesive layer, an insulating layer, and a protective layer.

### [5] Method for Producing Lithium-Ion Secondary Battery

Next, a method for producing the above-mentioned lithium-ion secondary battery will be described.

In the method for producing the lithium-ion secondary battery according to the present disclosure, the solid composition according to the present disclosure as described above is used, and the method for producing a solid electrolyte molded body according to the present disclosure described above can be applied.

### [5-1] Method for Producing Lithium-Ion Secondary Battery of First Embodiment

Hereinafter, a method for producing the lithium-ion secondary battery according to the first embodiment will be described.

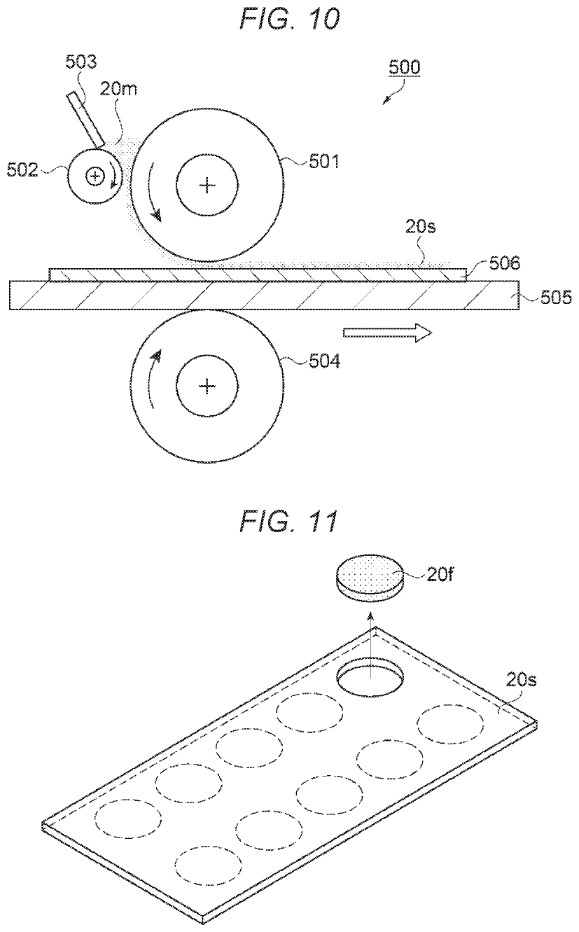

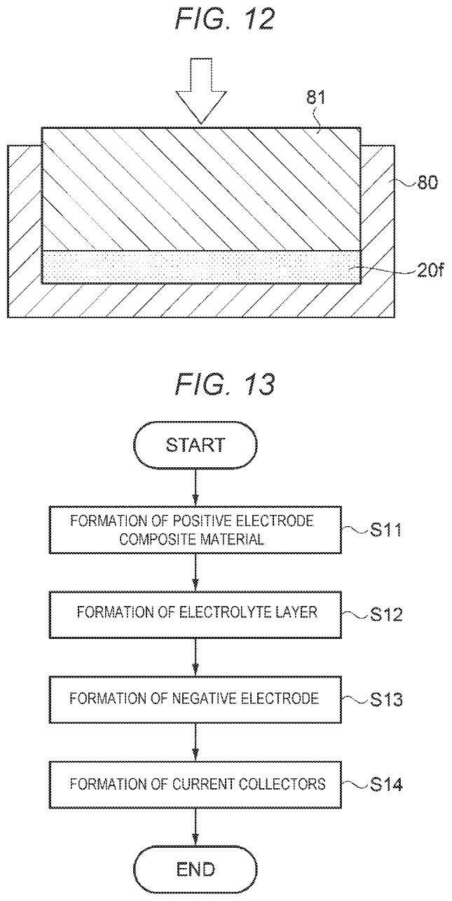

FIG. 9 is a flowchart showing the method for producing the lithium-ion secondary battery of the first embodiment, FIGS. 10 and 11 are schematic views schematically showing the method for producing the lithium-ion secondary battery of the first embodiment, and FIG. 12 is a schematic cross-sectional view schematically showing another method for forming a solid electrolyte layer.

As shown in FIG. 9, the method for producing the lithium-ion secondary battery 100 of this embodiment includes Step S1, Step S2, Step S3, and Step S4.

Step S1 is a step of forming the solid electrolyte layer 20. Step S2 is a step of forming the positive electrode 10. Step S3 is a step of forming the negative electrode 30. Step S4 is a step of forming the current collectors 41 and 42.

### [5-1-1] Step S1

In the step of forming the solid electrolyte layer 20 of Step S1, the solid electrolyte layer 20 is formed by, for example, a green sheet method using the solid composition according to the present disclosure. More specifically, the solid electrolyte layer 20 can be formed as follows.

That is, first, for example, a solution in which a binder such as polypropylene carbonate is dissolved in a solvent such as 1,4-dioxane is prepared, and the solution and the solid composition according to the present disclosure are mixed, whereby a slurry 20m is obtained. In the preparation of the slurry 20m, a dispersant, a diluent, a humectant, or the like may be further used as needed.

Subsequently, by using the slurry 20m, a solid electrolyte layer forming sheet 20s is formed. More specifically, as shown in FIG. 10, for example, by using a fully automatic film applicator 500, the slurry 20m is applied to a predetermined thickness onto the base material 506 such as a polyethylene terephthalate film, whereby the solid electrolyte layer forming sheet 20s is formed. The fully automatic film applicator 500 includes an application roller 501 and a doctor roller 502. A squeegee 503 is provided so as to come in contact with the doctor roller 502 from above. A conveyance roller 504 is provided below the application roller 501 at a position opposite thereto, and a stage 505 on which the base material 506 is placed is conveyed in a fixed direction by inserting the stage 505 between the application roller 501 and the conveyance roller 504. The slurry 20m is fed to a side where the squeegee 503 is provided between the application roller 501 and the doctor roller 502 disposed with a gap therebetween in the conveyance direction of the stage 505. The slurry 20m with a predetermined thickness is applied to the surface of the application roller 501 by rotating the application roller 501 and the doctor roller 502 so as to extrude the slurry 20m downward from the gap. Then, along with this, by rotating the conveyance roller 504, the stage 505 is conveyed so that the base material 506 comes in contact with the application roller 501 to which the slurry 20m has been applied. By doing this, the slurry 20m applied to the application roller 501 is transferred in a sheet form to the base material 506, whereby the solid electrolyte layer forming sheet 20s is formed.

Thereafter, the solvent is removed from the solid electrolyte layer forming sheet 20s formed on the base material 506, and the solid electrolyte layer forming sheet 20s is detached from the base material 506 and punched to a predetermined size using a punching die as shown in FIG. 11, whereby a molded material 20f is formed. This treatment corresponds to the molding step in the method for producing a solid electrolyte molded body according to the present disclosure described above.

Thereafter, by performing a heating step of heating the molded material 20f, the solid electrolyte layer 20 as a main fired body is obtained. This treatment corresponds to the heat treatment step in the method for producing a solid electrolyte molded body according to the present disclosure described above. Therefore, this treatment is preferably performed under the same conditions as described in the above-mentioned [3-2] Heat Treatment Step. According to this, the same effect as described above is obtained.

The solid electrolyte layer forming sheet 20s with a predetermined thickness may be formed by pressing and extruding the slurry 20m by the application roller 501 and the doctor roller 502 so that the sintered density of the solid electrolyte layer 20 after firing becomes 90% or more.

### [5-1-2] Step S2

After Step S1, the process proceeds to Step S2.

In the step of forming the positive electrode 10 of Step S2, the positive electrode 10 is formed at one face of the solid electrolyte layer 20. More specifically, for example, first, by using a sputtering device, sputtering is performed using LiCoO₂ as a target in an inert gas such as argon gas, whereby a LiCoO₂ layer is formed at a surface of the solid electrolyte layer 20. Thereafter, the LiCoO₂ layer formed on the solid electrolyte layer 20 is fired in an oxidizing atmosphere so as to convert the crystal of the LiCoO₂ layer into a high-temperature phase crystal, whereby the LiCoO₂ layer can be converted into the positive electrode 10. The firing conditions of the LiCoO₂ layer are not particularly limited, but the heating temperature can be set to 400° C. or higher and 600° C. or lower, and the heating time can be set to 1 hour or more and 3 hours or less.

### [5-1-3] Step S3

After Step S2, the process proceeds to Step S3.

In the step of forming the negative electrode 30 of Step S3, the negative electrode 30 is formed at the other face of the solid electrolyte layer 20, that is, a face at an opposite side from the face at which the positive electrode 10 is formed. More specifically, for example, by using a vacuum deposition device or the like, the negative electrode 30 can be formed by forming a thin film of metal Li at a face of the solid electrolyte layer 20 at an opposite side from the face at which the positive electrode 10 is formed. The thickness of the negative electrode 30 can be set to, for example, 0.1 μm or more and 500 μm or less.

### [5-1-4] Step S4

After Step S3, the process proceeds to Step S4.

In the step of forming the current collectors 41 and 42 of Step S4, the current collector 41 is formed so as to come in contact with the positive electrode 10, and the current collector 42 is formed so as to come in contact with the negative electrode 30. More specifically, for example, an aluminum foil formed into a circular shape by punching or the like is joined to the positive electrode 10 by pressing, whereby the current collector 41 can be formed. Further, for example, a copper foil formed into a circular shape by punching or the like is joined to the negative electrode 30 by pressing, whereby the current collector 42 can be formed. The thickness of each of the current collectors 41 and 42 is not particularly limited, but can be set to, for example, 10 μm or more and 60 μm or less. In this step, only one of the current collectors 41 and 42 may be formed.

The method for forming the solid electrolyte layer 20 is not limited to the green sheet method shown in Step S1. As another method for forming the solid electrolyte layer 20, for example, a method as described below can be adopted. That is, as shown in FIG. 12, the molded material 20f may be obtained by filling the solid composition according to the present disclosure in a powder form in a pellet die 80, closing the pellet die using a lid 81, and pressing the lid 81 to perform uniaxial press molding. A treatment for the molded material 20f thereafter can be performed in the same manner as described above. As the pellet die 80, a die including an exhaust port (not shown) can be favorably used.

### [5-2] Method for Producing Lithium-Ion Secondary Battery of Second Embodiment

Next, a method for producing the lithium-ion secondary battery according to the second embodiment will be described.

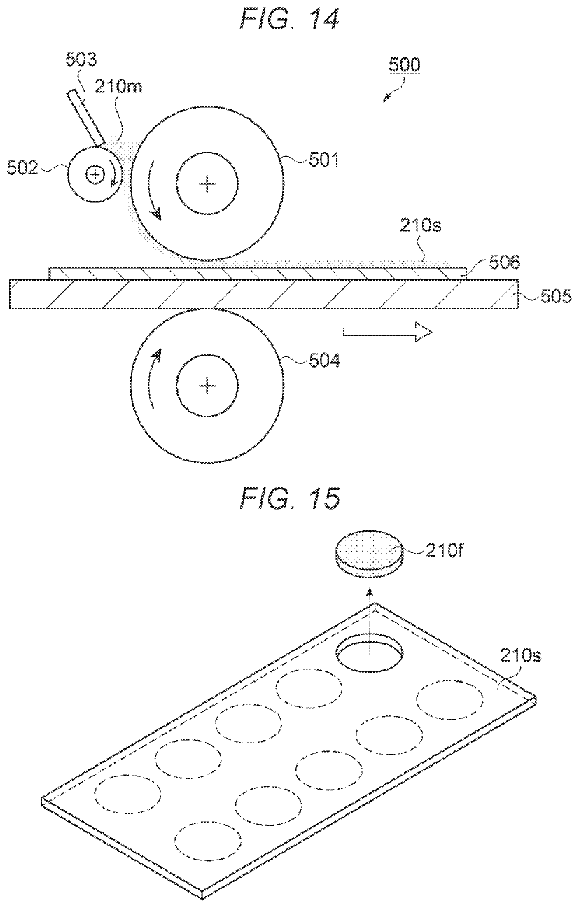

FIG. 13 is a flowchart showing the method for producing the lithium-ion secondary battery of the second embodiment, and FIGS. 14 and 15 are schematic views schematically showing the method for producing the lithium-ion secondary battery of the second embodiment.

Hereinafter, the method for producing the lithium-ion secondary battery according to the second embodiment will be described with reference to these drawings, but different points from the above-mentioned embodiment will be mainly described, and the description of the same matter will be omitted.

As shown in FIG. 13, the method for producing the lithium-ion secondary battery 100 of this embodiment includes Step S11, Step S12, Step S13, and Step S14.

Step S11 is a step of forming the positive electrode composite material 210. Step S12 is a step of forming the electrolyte layer 220. Step S13 is a step of forming the negative electrode 30. Step S14 is a step of forming the current collectors 41 and 42.

### [5-2-1] Step S11

In the step of forming the positive electrode composite material 210 of Step S11, the positive electrode composite material 210 is formed.

The positive electrode composite material 210 can be formed, for example, as follows.

That is, first, for example, a slurry 210m as a mixture of the positive electrode active material 211 such as LiCoO₂, the solid composition according to the present disclosure, a binder such as polypropylene carbonate, and a solvent such as 1,4-dioxane is obtained. In the preparation of the slurry 210m, a dispersant, a diluent, a humectant, or the like may be further used as needed.

Subsequently, by using the slurry 210m, a positive electrode composite material forming sheet 210s is formed. More specifically, as shown in FIG. 14, for example, by using a fully automatic film applicator 500, the slurry 210m is applied to a predetermined thickness onto the base material 506 such as a polyethylene terephthalate film, whereby the positive electrode composite material forming sheet 210s is formed.

Thereafter, the solvent is removed from the positive electrode composite material forming sheet 210s formed on the base material 506, and the positive electrode composite material forming sheet 210s is detached from the base material 506 and punched to a predetermined size using a punching die as shown in FIG. 15, whereby a molded material 210f is formed. This treatment corresponds to the molding step in the method for producing a solid electrolyte molded body according to the present disclosure described above.

Thereafter, by performing a heating step of heating the molded material 210f, the positive electrode composite material 210 including a solid electrolyte is obtained. This treatment corresponds to the heat treatment step in the method for producing a solid electrolyte molded body according to the present disclosure described above. Therefore, this treatment is preferably performed under the same conditions as described in the above-mentioned [3-2]Heat Treatment Step. According to this, the same effect as described above is obtained.

### [5-2-2] Step S12

After Step S11, the process proceeds to Step S12.

In the step of forming the electrolyte layer 220 of Step S12, the electrolyte layer 220 is formed at one face 210b of the positive electrode composite material 210. More specifically, for example, by using a sputtering device, sputtering is performed using LLZSTO (Li_{6.3}La₃Zr_{1.3}Sb_{0.5}Ta_{0.2}O₇) as a target in an inert gas such as argon gas, whereby an LLZSTO layer is formed at a surface of the positive electrode composite material 210. Thereafter, the LLZSTO layer formed on the positive electrode composite material 210 is fired in an oxidizing atmosphere so as to convert the crystal of the LLZSTO layer into a high-temperature phase crystal, whereby the LLZSTO layer can be converted into the electrolyte layer 220. The firing conditions of the LLZSTO layer are not particularly limited, but the heating temperature can be set to 500° C. or higher and 900° C. or lower, and the heating time can be set to 1 hour or more and 3 hours or less.

### [5-2-3] Step S13

After Step S12, the process proceeds to Step S13.

In the step of forming the negative electrode 30 of Step S13, the negative electrode 30 is formed at an opposite face side of the electrolyte layer 220 from a face thereof facing the positive electrode composite material 210. More specifically, for example, by using a vacuum deposition device or the like, the negative electrode 30 can be formed by forming a thin film of metal Li at an opposite face side of the electrolyte layer 220 from a face thereof facing the positive electrode composite material 210.

### [5-2-4] Step S14

After Step S13, the process proceeds to Step S14.

In the step of forming the current collectors 41 and 42 of Step S14, the current collector 41 is formed so as to come in contact with the other face of the positive electrode composite material 210, that is, a face 210a at an opposite side from the face 210b at which the electrolyte layer 220 is formed, and the current collector 42 is formed so as to come in contact with the negative electrode 30.

The methods for forming the positive electrode composite material 210 and the electrolyte layer 220 are not limited to the above-mentioned methods. For example, the positive electrode composite material 210 and the electrolyte layer 220 may be formed as follows. That is, first, a slurry as a mixture of the solid composition according to the present disclosure, a binder, and a solvent is obtained. Then, the obtained slurry is fed to a fully automatic film applicator 500 and applied onto the base material 506, whereby an electrolyte forming sheet is formed. Thereafter, the electrolyte forming sheet and the positive electrode composite material forming sheet 210s formed in the same manner as described above are pressed in a stacked state and bonded to each other. Thereafter, a stacked sheet obtained by bonding the sheets is punched to form a molded material, and the molded material is fired in an oxidizing atmosphere, whereby a stacked body of the positive electrode composite material 210 and the electrolyte layer 220 may be obtained.

### [5-3] Method for Producing Lithium-Ion Secondary Battery of Third Embodiment

Next, a method for producing the lithium-ion secondary battery according to the third embodiment will be described.

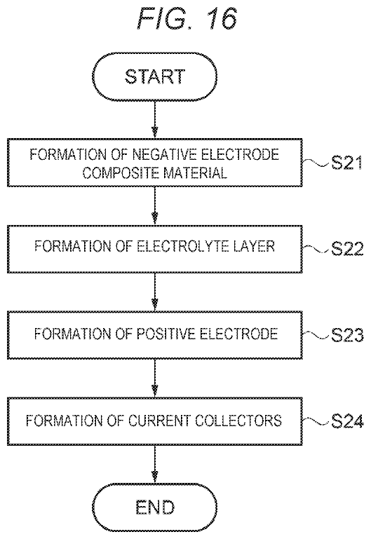

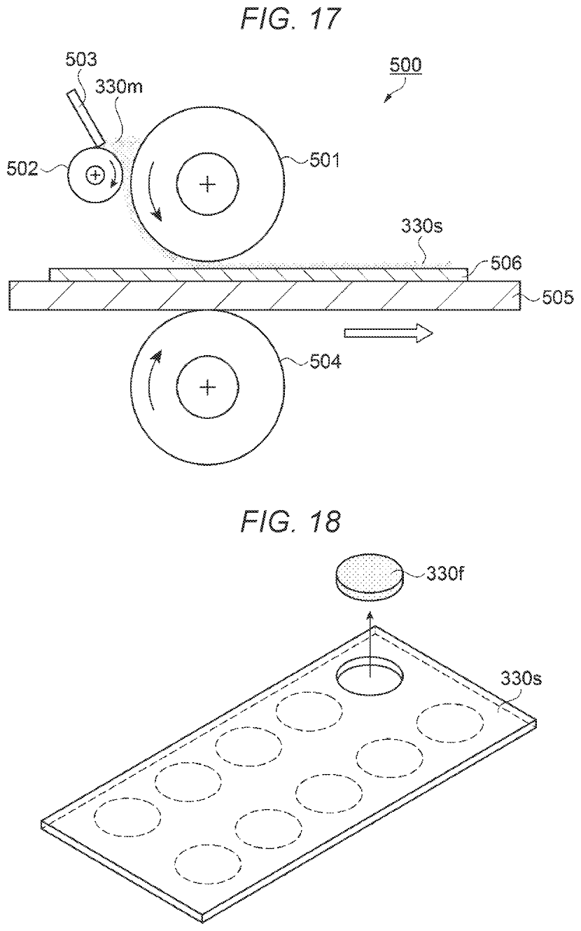

FIG. 16 is a flowchart showing the method for producing the lithium-ion secondary battery of the third embodiment, and FIGS. 17 and 18 are schematic views schematically showing the method for producing the lithium-ion secondary battery of the third embodiment.

Hereinafter, the method for producing the lithium-ion secondary battery according to the third embodiment will be described with reference to these drawings, but different points from the above-mentioned embodiments will be mainly described, and the description of the same matter will be omitted.

As shown in FIG. 16, the method for producing the lithium-ion secondary battery 100 of this embodiment includes Step S21, Step S22, Step S23, and Step S24.

Step S21 is a step of forming the negative electrode composite material 330. Step S22 is a step of forming the electrolyte layer 220. Step S23 is a step of forming the positive electrode 10. Step S24 is a step of forming the current collectors 41 and 42.

### [5-3-1] Step S21

In the step of forming the negative electrode composite material 330 of Step S21, the negative electrode composite material 330 is formed.

The negative electrode composite material 330 can be formed, for example, as follows.

That is, first, for example, a slurry 330m as a mixture of the negative electrode active material 331 such as Li₄Ti₅O₁₂, the solid composition according to the present disclosure, a binder such as polypropylene carbonate, and a solvent such as 1,4-dioxane is obtained. In the preparation of the slurry 330m, a dispersant, a diluent, a humectant, or the like may be further used as needed.

Subsequently, by using the slurry 330m, a negative electrode composite material forming sheet 330s is formed. More specifically, as shown in FIG. 17, for example, by using a fully automatic film applicator 500, the slurry 330m is applied to a predetermined thickness onto the base material 506 such as a polyethylene terephthalate film, whereby the negative electrode composite material forming sheet 330s is formed.

Thereafter, the solvent is removed from the negative electrode composite material forming sheet 330s formed on the base material 506, and the negative electrode composite material forming sheet 330s is detached from the base material 506 and punched to a predetermined size using a punching die as shown in FIG. 18, whereby a molded material 330f is formed. This treatment corresponds to the molding step in the method for producing a solid electrolyte molded body according to the present disclosure described above.

Thereafter, by performing a heating step of heating the molded material 330f, the negative electrode composite material 330 including a solid electrolyte is obtained. This treatment corresponds to the heat treatment step in the method for producing a solid electrolyte molded body according to the present disclosure described above. Therefore, this treatment is preferably performed under the same conditions as described in the above-mentioned [3-2]Heat Treatment Step. According to this, the same effect as described above is obtained.

### [5-3-2] Step S22

After Step S21, the process proceeds to Step S22.

In the step of forming the electrolyte layer 220 of Step S22, the electrolyte layer 220 is formed at one face 330a of the negative electrode composite material 330. More specifically, for example, by using a sputtering device, sputtering is performed using Li_{2.2}C_{0.8}B_{0.2}O₃ which is a solid solution of Li₂CO₃ and Li₃BO₃ as a target in an inert gas such as argon gas, whereby a Li_{2.2}C_{0.8}B_{0.2}O₃ layer is formed at a surface of the negative electrode composite material 330. Thereafter, the Li_{2.2}C_{0.8}B_{0.2}O₃ layer formed on the negative electrode composite material 330 is fired in an oxidizing atmosphere so as to convert the crystal of the Li_{2.2}C_{0.8}B_{0.2}O₃ layer into a high-temperature phase crystal, whereby the Li_{2.2}C_{0.8}B_{0.2}O₃ layer can be converted into the electrolyte layer 220. The firing conditions of the Li_{2.2}C_{0.8}B_{0.2}O₃ layer are not particularly limited, but the heating temperature can be set to 400° C. or higher and 600° C. or lower, and the heating time can be set to 1 hour or more and 3 hours or less.

### [5-3-3] Step S23

After Step S22, the process proceeds to Step S23.

In the step of forming the positive electrode 10 of Step S23, the positive electrode 10 is formed at one face 220a side of the electrolyte layer 220, that is, an opposite face side of the electrolyte layer 220 from a face thereof facing the negative electrode composite material 330. More specifically, for example, first, by using a vacuum deposition device or the like, a LiCoO₂ layer is formed at one face 220a of the electrolyte layer 220. Thereafter, a stacked body of the electrolyte layer 220 at which the LiCoO₂ layer is formed, and the negative electrode composite material 330 is fired so as to convert the crystal of the LiCoO₂ layer into a high-temperature phase crystal, whereby the LiCoO₂ layer can be converted into the positive electrode 10. The firing conditions of the LiCoO₂ layer are not particularly limited, but the heating temperature can be set to 400° C. or higher and 600° C. or lower, and the heating time can be set to 1 hour or more and 3 hours or less.

### [5-3-4] Step S24

After Step S23, the process proceeds to Step S24.

In the step of forming the current collectors 41 and 42 of Step S24, the current collector 41 is formed so as to come in contact with one face 10a of the positive electrode 10, that is, the face 10a of the positive electrode 10 at an opposite side from the face at which the electrolyte layer 220 is formed, and the current collector 42 is formed so as to come in contact with the other face of the negative electrode composite material 330, that is, a face 330b of the negative electrode composite material 330 at an opposite side from the face 330a at which the electrolyte layer 220 is formed.

The methods for forming the negative electrode composite material 330 and the electrolyte layer 220 are not limited to the above-mentioned methods. For example, the negative electrode composite material 330 and the electrolyte layer 220 may be formed as follows. That is, first, a slurry as a mixture of the solid composition according to the present disclosure, a binder, and a solvent is obtained. Then, the obtained slurry is fed to a fully automatic film applicator 500 and applied onto the base material 506, whereby an electrolyte forming sheet is formed. Thereafter, the electrolyte forming sheet and the negative electrode composite material forming sheet 330s formed in the same manner as described above are pressed in a stacked state and bonded to each other. Thereafter, a stacked sheet obtained by bonding the sheets is punched to form a molded material, and the molded material is fired in an oxidizing atmosphere, whereby a stacked body of the negative electrode composite material 330 and the electrolyte layer 220 may be obtained.

### [5-4] Method for Producing Lithium-Ion Secondary Battery of Fourth Embodiment

Next, a method for producing the lithium-ion secondary battery according to the fourth embodiment will be described.

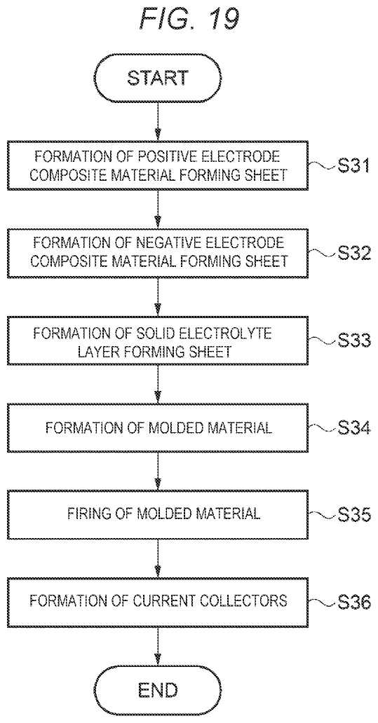

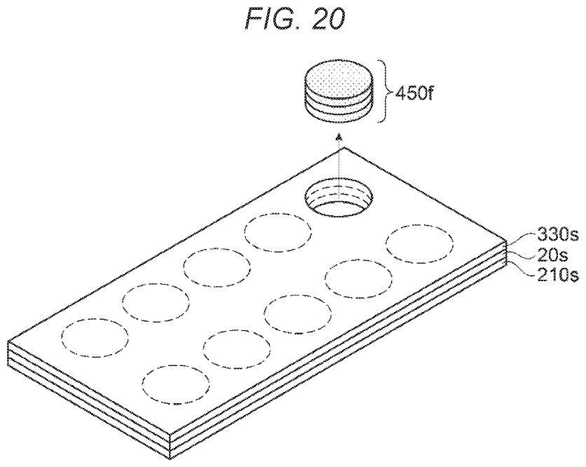

FIG. 19 is a flowchart showing the method for producing the lithium-ion secondary battery of the fourth embodiment, and FIG. 20 is a schematic view schematically showing the method for producing the lithium-ion secondary battery of the fourth embodiment.

Hereinafter, the method for producing the lithium-ion secondary battery according to the fourth embodiment will be described with reference to these drawings, but different points from the above-mentioned embodiments will be mainly described, and the description of the same matter will be omitted.

As shown in FIG. 19, the method for producing the lithium-ion secondary battery 100 of this embodiment includes Step S31, Step S32, Step S33, Step S34, Step S35, and Step S36.

Step S31 is a step of forming a sheet for forming the positive electrode composite material 210. Step S32 is a step of forming a sheet for forming the negative electrode composite material 330. Step S33 is a step of forming a sheet for forming the solid electrolyte layer 20. Step S34 is a step of forming a molded material 450f of molding a stacked body of the sheet for forming the positive electrode composite material 210, the sheet for forming the negative electrode composite material 330, and the sheet for forming the solid electrolyte layer 20 into a predetermined shape. Step S35 is a step of firing the molded material 450f. Step S36 is a step of forming the current collectors 41 and 42.

In the following description, a description will be made by assuming that Step S32 is performed after Step S31, and Step S33 is performed after Step S32, however, the order of Step S31, Step S32, and Step S33 is not limited thereto, and the order of the steps may be changed, or the steps may be concurrently performed.

### [5-4-1] Step S31

In the step of forming a sheet for forming the positive electrode composite material 210 of Step S31, a positive electrode composite material forming sheet 210s that is the sheet for forming the positive electrode composite material 210 is formed.

The positive electrode composite material forming sheet 210s can be formed, for example, in the same manner as described in the above second embodiment.

The positive electrode composite material forming sheet 210s obtained in this step is preferably one obtained by removing the solvent from the slurry 210m used for forming the positive electrode composite material forming sheet 210s.

### [5-4-2] Step S32

After Step S31, the process proceeds to Step S32.

In the step of forming a sheet for forming the negative electrode composite material 330 of Step S32, a negative electrode composite material forming sheet 330s that is the sheet for forming the negative electrode composite material 330 is formed.

The negative electrode composite material forming sheet 330s can be formed, for example, in the same manner as described in the above third embodiment.

The negative electrode composite material forming sheet 330s obtained in this step is preferably one obtained by removing the solvent from the slurry 330m used for forming the negative electrode composite material forming sheet 330s.

### [5-4-3] Step S33

After Step S32, the process proceeds to Step S33.

In the step of forming a sheet for forming the solid electrolyte layer 20 of Step S33, a solid electrolyte layer forming sheet 20s that is the sheet for forming the solid electrolyte layer 20 is formed.

The solid electrolyte layer forming sheet 20s can be formed, for example, in the same manner as described in the above first embodiment.

The solid electrolyte layer forming sheet 20s obtained in this step is preferably one obtained by removing the solvent from the slurry 20m used for forming the solid electrolyte layer forming sheet 20s.

### [5-4-4] Step S34

After Step S33, the process proceeds to Step S34.

In the step of forming the molded material 450f of Step S34, the positive electrode composite material forming sheet 210s, the solid electrolyte layer forming sheet 20s, and the negative electrode composite material forming sheet 330s are pressed in a state of being stacked in this order and bonded to one another. Thereafter, as shown in FIG. 20, a stacked sheet obtained by bonding the sheets is punched, whereby the molded material 450f is obtained.

### [5-4-5] Step S35

After Step S34, the process proceeds to Step S35.

In the step of firing the molded material 450f of Step S35, by performing a heating step of heating the molded material 450f, a portion constituted by the positive electrode composite material forming sheet 210s is converted into the positive electrode composite material 210, a portion constituted by the solid electrolyte layer forming sheet 20s is converted into the solid electrolyte layer 20, and a portion constituted by the negative electrode composite material forming sheet 330s is converted into the negative electrode composite material 330. That is, a fired body of the molded material 450f is a stacked body of the positive electrode composite material 210, the solid electrolyte layer 20, and the negative electrode composite material 330. This treatment corresponds to the heat treatment step in the method for producing a solid electrolyte molded body according to the present disclosure described above. Therefore, this treatment is preferably performed under the same conditions as described in the above-mentioned [3-2] Heat Treatment Step. According to this, the same effect as described above is obtained.

### [5-4-6] Step S36

After Step S35, the process proceeds to Step S36.

In the step of forming the current collectors 41 and 42 of Step S36, the current collector 41 is formed so as to come in contact with the face 210a of the positive electrode composite material 210, and the current collector 42 is formed so as to come in contact with the face 330b of the negative electrode composite material 330.

Hereinabove, preferred embodiments of the present disclosure have been described, however, the present disclosure is not limited thereto.

For example, the solid composition according to the present disclosure is not limited to one produced by the above-mentioned method.

Further, when the present disclosure is applied to a lithium-ion secondary battery, the configuration of the lithium-ion secondary battery is not limited to those of the above-mentioned embodiments.

For example, when the present disclosure is applied to a lithium-ion secondary battery, the lithium-ion secondary battery is not limited to an all-solid-state battery, and may be, for example, a lithium-ion secondary battery in which a porous separator is provided between a positive electrode composite material and a negative electrode, and the separator is impregnated with an electrolyte solution.

Further, the solid composition according to the present disclosure may be applied to the production of a separator. In such a case, excellent dendrite resistance is obtained.

Further, when the present disclosure is applied to a lithium-ion secondary battery, the production method therefor is not limited to those of the above-mentioned embodiments. For example, the order of the steps in the production of the lithium-ion secondary battery may be made different from that in the above-mentioned embodiments.

Further, the method for producing a solid electrolyte molded body according to the present disclosure may include a step other than the molding step and the heat treatment step described above.

### EXAMPLES

Next, specific Examples of the present disclosure will be described.

### [6] Production of First Particles and Second Particles

First, multiple types of first particles and second particles were produced as follows, respectively.

### [6-1] Production of First Particles Production Example A1

First, 2.59 parts by mass of a Li₂CO₃ powder as a lithium source, 4.89 parts by mass of a La₂O₃ powder as a lanthanum source, and 2.46 parts by mass of a ZrO₂ powder as a zirconium source were prepared, and these powders were ground and mixed using an agate mortar, whereby a mixture was obtained.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and sintered in an air atmosphere at 1250° C. for 8 hours, whereby a solid electrolyte pellet constituted by Li₇La₃Zr₂O₁₂ was obtained.

Thereafter, the solid electrolyte pellet was ground using an agate mortar, whereby Li₇La₃Zr₂O₁₂ particles having an average particle diameter of 20 μm were obtained, which were used as first particles.

### Production Example A2

Li₇La₃Zr₂O₁₂ particles were obtained in the same manner as in the above Production Example A1 except that the average particle diameter of the Li₇La₃Zr₂O₁₂ particles was adjusted to 10 μm, which were used as first particles.

### Production Example A3

Li₇La₃Zr₂O₁₂ particles were obtained in the same manner as in the above Production Example A1 except that the average particle diameter of the Li₇La₃Zr₂O₁₂ particles was adjusted to 5 μm, which were used as first particles.

### Production Example A4

Li₇La₃Zr₂O₁₂ particles were obtained in the same manner as in the above Production Example A1 except that the average particle diameter of the Li₇La₃Zr₂O₁₂ particles was adjusted to 3 μm, which were used as first particles.

### Production Example A5

Li₇La₃Zr₂O₁₂ particles were obtained in the same manner as in the above Production Example A1 except that the average particle diameter of the Li₇La₃Zr₂O₁₂ particles was adjusted to 1 μm, which were used as first particles.

### Production Example A6

A plate-shaped Li-substituted NASICON-type LATP solid electrolyte (Li_{1+x+y}AlₓTi₂₋ₓSi_{y}P_{3-y}O₁₂) (manufactured by Ohara Corporation) was prepared and ground using an agate mortar, whereby an LATP solid electrolyte powder having an average particle diameter of 20 μm was obtained, which was used as first particles

### Production Example A7

An LATP solid electrolyte powder was obtained in the same manner as in the above Production Example A6 except that the average particle diameter of the LATP solid electrolyte powder was adjusted to 10 μm, which was used as first particles

### Production Example A8

An LATP solid electrolyte powder was obtained in the same manner as in the above Production Example A6 except that the average particle diameter of the LATP solid electrolyte powder was adjusted to 5 μm, which was used as first particles.

### Production Example A9

An LATP solid electrolyte powder was obtained in the same manner as in the above Production Example A6 except that the average particle diameter of the LATP solid electrolyte powder was adjusted to 3 μm, which was used as first particles

### Production Example A10

An LATP solid electrolyte powder was obtained in the same manner as in the above Production Example A6 except that the average particle diameter of the LATP solid electrolyte powder was adjusted to 1 μm, which was used as first particles

### Production Example A11

First, 1.07 parts by mass of a Li₂CO₃ powder as a lithium source, 9.29 parts by mass of a La₂O₃ powder as a lanthanum source, and 7.99 parts by mass of a TiO₂ powder as a titanium source were prepared, and these powders were ground and mixed using an agate mortar, whereby a mixture was obtained.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and fired in an air atmosphere at 1150° C. for 2 hours, and further fired at 1450° C. for 6 hours, whereby a solid electrolyte pellet constituted by Li_{0.29}La_{0.57}TiO₃ was obtained.

Thereafter, the solid electrolyte pellet was ground using an agate mortar, whereby Li_{0.29}La_{0.57}TiO₃ particles having an average particle diameter of 20 μm were obtained, which were used as first particles

### Production Example A12

Li_{0.29}La_{0.57}TiO₃ particles were obtained in the same manner as in the above Production Example A11 except that the average particle diameter of the Li_{0.29}La_{0.57}TiO₃ particles was adjusted to 10 μm, which were used as first particles

### Production Example A13

Li_{0.29}La_{0.57}TiO₃ particles were obtained in the same manner as in the above Production Example A11 except that the average particle diameter of the Li_{0.29}La_{0.57}TiO₃ particles was adjusted to 5 μm, which were used as first particles.

### Production Example A14

Li_{0.29}La_{0.57}TiO₃ particles were obtained in the same manner as in the above Production Example A11 except that the average particle diameter of the Li_{0.29}La_{0.57}TiO₃ particles was adjusted to 3 μm, which were used as first particles

### Production Example A15

Li_{0.29}La_{0.57}TiO₃ particles were obtained in the same manner as in the above Production Example A11 except that the average particle diameter of the Li_{0.29}La_{0.57}TiO₃ particles was adjusted to 1 μm, which were used as first particles

### Production Example A16

First, a first solution containing lanthanum nitrate hexahydrate as a lanthanum source, zirconium tetra-n-butoxide as a zirconium source, antimony tri-n-butoxide as an antimony source, tantalum pentaethoxide as a tantalum source, and 2-n-butoxyethanol as a solvent at a predetermined ratio was prepared, and a second solution containing lithium nitrate as a lithium compound and 2-n-butoxyethanol as a solvent at a predetermined ratio was prepared.

Subsequently, the first solution and the second solution were mixed at a predetermined ratio, whereby a mixed liquid in which the content ratio of Li, La, Zr, Sb, and Ta was 6.3:3:1.3:0.5:0.2 in molar ratio was obtained.

Subsequently, the thus obtained mixed liquid was subjected to a first heat treatment in the air at 140° C. for 20 minutes in a state of being placed in a beaker made of titanium, whereby a mixture in a gel form was obtained.

Subsequently, the thus obtained mixture in a gel form was subjected to a second heat treatment in the air at 540° C. for 20 minutes, whereby a thermally decomposed product in an ash form was obtained.

1 g of the resulting thermally decomposed product in an ash form was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and fired in an air atmosphere at 900° C. for 1 hour, whereby a solid electrolyte pellet constituted by Li_{6.3}La_{3.0}Zr_{1.3}Sb_{0.5}Ta_{0.2}O₁₂ was obtained.

Thereafter, the solid electrolyte pellet was ground using an agate mortar, whereby Li_{6.3}La_{3.0}Zr_{1.3}Sb_{0.5}Ta_{0.2}O₁₂ particles having an average particle diameter of 20 μm were obtained, which were used as first particles

### Production Example A17

Li_{6.3}La_{3.0}Zr_{1.3}Sb_{0.5}Ta_{0.2}O₁₂ particles were obtained in the same manner as in the above Production Example A16 except that the average particle diameter of the Li_{6.3}La_{3.0}Zr_{1.3}Sb_{0.5}Ta_{0.2}O₁₂ particles was adjusted to 10 μm, which were used as first particles

### Production Example A18

Li_{6.3}La_{3.0}Zr_{1.3}Sb_{0.5}Ta_{0.2}O₁₂ particles were obtained in the same manner as in the above Production Example A16 except that the average particle diameter of the Li_{6.3}La_{3.0}Zr_{1.3}Sb_{0.5}Ta_{0.2}O₁₂ particles was adjusted to 5 μm, which were used as first particles

### Production Example A19

Li_{6.3}La_{3.0}Zr_{1.3}Sb_{0.5}Ta_{0.2}O₁₂ particles were obtained in the same manner as in the above Production Example A16 except that the average particle diameter of the Li_{6.3}La_{3.0}Zr_{1.3}Sb_{0.5}Ta_{0.2}O₁₂ particles was adjusted to 3 μm, which were used as first particles

### Production Example A20

Li_{6.3}La_{3.0}Zr_{1.3}Sb_{0.5}Ta_{0.2}O₁₂ particles were obtained in the same manner as in the above Production Example A16 except that the average particle diameter of the Li_{6.3}La_{3.0}Zr_{1.3}Sb_{0.5}Ta_{0.2}O₁₂ particles was adjusted to 1 μm, which were used as first particles.

### [6-2] Production of Second Particles

### Production Example B1

First, a first solution containing lanthanum nitrate hexahydrate as a lanthanum source, zirconium tetra-n-butoxide as a zirconium source, antimony tri-n-butoxide as an antimony source, tantalum pentaethoxide as a tantalum source, and 2-n-butoxyethanol as a solvent at a predetermined ratio was prepared, and a second solution containing lithium nitrate as a lithium compound and 2-n-butoxyethanol as a solvent at a predetermined ratio was prepared.

Subsequently, the first solution and the second solution were mixed at a predetermined ratio, whereby a mixed liquid having a formulation shown in Table 1 was obtained.

Subsequently, the thus obtained mixed liquid was subjected to a first heat treatment in the air at 140° C. for 20 minutes in a state of being placed in a beaker made of titanium, whereby a mixture in a gel form was obtained.

Subsequently, the thus obtained mixture in a gel form was subjected to a second heat treatment in the air at 540° C. for 20 minutes, whereby second particles as a thermally decomposed product in an ash form were obtained.

The second particles obtained in this manner contained a precursor oxide constituted by a pyrochlore-type crystal phase and lithium carbonate as a lithium compound.

### Production Examples B2 to B6

Second particles were produced in the same manner as in the above Production Example B1 except that the formulation of the mixed liquid is as shown in Table 1 or 2 by adjusting the types and used amounts of raw materials used in the preparation of the mixed liquid.

### Production Examples B7 to B9

Second particles were produced in the same manner as in the above Production Example B1 except that the formulation of the mixed liquid is as shown in Table 2 by adjusting the types and used amounts of raw materials used in the preparation of the mixed liquid

### Production Example B10

First, a first solution containing lanthanum nitrate hexahydrate as a lanthanum source, zirconium tetra-n-butoxide as a zirconium source, antimony tri-n-butoxide as an antimony source, tantalum pentaethoxide as a tantalum source, and 2-n-butoxyethanol as a solvent at a predetermined ratio was prepared, and a second solution containing lithium nitrate as a lithium compound and 2-n-butoxyethanol as a solvent at a predetermined ratio was prepared.

Subsequently, the first solution and the second solution were mixed at a predetermined ratio, whereby a mixed liquid having a formulation shown in Table 2 was obtained.

Subsequently, the thus obtained mixed liquid was subjected to a first heat treatment in the air at 140° C. for 20 minutes in a state of being placed in a beaker made of titanium, whereby a mixture in a gel form was obtained.

Subsequently, the thus obtained mixture in a gel form was subjected to a second heat treatment in the air at 540° C. for 20 minutes, whereby a thermally decomposed product in an ash form was obtained.

1 g of the resulting thermally decomposed product in an ash form was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and fired in an air atmosphere at 900° C. for 1 hour, whereby a solid electrolyte pellet was obtained.

Thereafter, the solid electrolyte pellet was ground using an agate mortar, whereby second particles having an average particle diameter of 3 μm were obtained. In this Production Example, the oxoacid compound was used in the production process, however, the finally obtained second particles did not contain the oxoacid compound. Further, the second particles obtained in this Production Example had a formulation represented by Li_{6.3}La₃Zr_{1.3}Sb_{0.5}Ta_{0.2}O₁₂

### Production Example B11

First, 25 parts by mass of a Li₂CO₃ powder as a lithium source, 4.9 parts by mass of a La₂O₃ powder as a lanthanum source, 2.16 parts by mass of a ZrO₂ powder as a zirconium source, and 0.55 parts by mass of a Ta₂O₅ powder as a tantalum source were prepared, and these powders were ground and mixed using an agate mortar, whereby a mixture was obtained.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and sintered in an air atmosphere at 1250° C. for 8 hours, whereby a solid electrolyte pellet constituted by Li_{6.25}La₃Zr_{1.75}Ta_{0.25}O₁₂ was obtained. Thereafter, the solid electrolyte pellet was ground using an agate mortar, whereby particles having an average particle diameter of 3 μm were obtained as second particles

### Production Example B12

First, 23.5 parts by mass of a Li₂CO₃ powder as a lithium source, 4.9 parts by mass of a La₂O₃ powder as a lanthanum source, 1.66 parts by mass of a ZrO₂ powder as a zirconium source, 0.34 parts by mass of a Nb₂O₅ powder as a niobium source, and 0.58 parts by mass of Sb₂O₃ powder as an antimony source were prepared, and these powders were ground and mixed using an agate mortar, whereby a mixture was obtained.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and sintered in an air atmosphere at 1250° C. for 8 hours, whereby a solid electrolyte pellet constituted by Li_{6.35}La₃Zr_{1.35}Nb_{0.25}Sb_{0.4}O₁₂ was obtained. Thereafter, the solid electrolyte pellet was ground using an agate mortar, whereby particles having an average particle diameter of 3 μm were obtained as second particles.

With respect to samples of the second particles of the above Production Examples B1 to B12, the elemental distribution and formulation were examined by various analytical methods, and from the transmission electron microscopic observation using JEM-ARM200F manufactured by JEOL Ltd. and the results of selected area electron diffraction, it was confirmed that the samples of the above Production Examples B1 to B6 are constituted by an amorphous region having a relatively large size of about several hundred nanometers or more, and a region of an assembly composed of nanocrystals with a size of 30 nm or less. Further, by energy dispersive X-ray spectroscopy and energy loss spectroscopy using a detector JED-2300T manufactured by JEOL Ltd., in the samples of the above Production Examples B1 to B6, lithium, carbon, and oxygen were detected from the amorphous region, and lanthanum, zirconium, and the element M were detected from the region of an assembly composed of nanocrystals.

The formulations of the mixed liquids used in the production of the second particles of the above Production Examples B1 to B10 are collectively shown in Tables 1 and 2, and the conditions of the second particles of the above Production Examples B1 to B12 are collectively shown in Table 3. Further, in Table 3, the value of XO/XP, the value of XL/XP, and the value of XO/XL when the content of the oxoacid compound in the second particles is represented by XO [mass %], the content of the precursor oxide in the second particles is represented by XP [mass %], and the content of the lithium compound in the second particles is represented by XL [mass %] are also shown. Note that in all the first particles and the second particles obtained in the respective Production Examples, the content of the solvent was 0.1 mass % or less. Further, when some of the second particles of the above Production Examples B1 to B6 were measured by TG-DTA at a temperature raising rate of 10° C./min, only one exothermic peak was observed in a range of 300° C. or higher and 1,000° C. or lower in all cases. From the results, it can be said that the precursor oxides constituting the second particles of the above Production Examples B1 to B6 are constituted by a substantially single crystal phase.

TABLE 1

| | Formulation of mixed liquid | | | |
|---|---|---|---|---|
| | Raw material compound | | Solvent | |
| | | Content | | Content |
| | | [parts by | | [parts by |
| | Type | mass] | Type | mass] |
| Production | zirconium tetra-n-butoxide | 5.00 | 2-n- | 304 |
| Example B1 | antimony tri-n-butoxide | 1.71 | butoxyethanol | |
| | tantalum pentaethoxide | 0.81 | | |
| | lithium nitrate | 4.34 | | |
| | lanthanum nitrate hexahydrate | 12.99 | | |
| Production | zirconium tetra-n-butoxide | 5.00 | 2-n- | 304 |
| Example B2 | antimony tri-n-butoxide | 1.71 | butoxyethanol | |
| | tantalum pentaethoxide | 0.81 | | |
| | lithium sulfate | 3.46 | | |
| | lanthanum nitrate hexahydrate | 12.99 | | |
| Production | zirconium tetra-n-butoxide | 6.71 | 2-n- | 304 |
| Example B3 | tantalum pentaethoxide | 1.02 | butoxyethanol | |
| | lithium nitrate | 4.65 | | |
| | lanthanum nitrate hexahydrate | 12.99 | | |
| Production | zirconium tetra-n-butoxide | 6.71 | 2-n- | 304 |
| Example B4 | tantalum pentaethoxide | 1.02 | butoxyethanol | |
| | lithium sulfate | 3.71 | | |
| | lanthanum nitrate hexahydrate | 12.99 | | |
| Production | zirconium tetra-n-butoxide | 6.71 | 2-n- | 304 |
| Example B5 | niobium pentaethoxide | 0.80 | butoxyethanol | |
| | lithium nitrate | 4.65 | | |
| | lanthanum nitrate hexahydrate | 12.99 | | |

TABLE 2

| | Formulation of mixed liquid | | | |
|---|---|---|---|---|
| | Raw material compound | | Solvent | |
| | | Content | | Content |
| | | [parts by | | [parts by |
| | Type | mass] | Type | mass] |
| Production | zirconium tetra-n-butoxide | 6.71 | 2-n- | 304 |
| Example B6 | niobium pentaethoxide | 0.80 | butoxyethanol | |
| | lithium sulfate | 3.71 | | |
| | lanthanum nitrate hexahydrate | 12.99 | | |
| Production | zirconium tetra-n-butoxide | 5.00 | 2-n- | 304 |
| Example B7 | antimony tri-n-butoxide | 1.71 | butoxyethanol | |
| | tantalum pentaethoxide | 0.81 | | |
| | lithium 2-ethy I hexanoate | 9.45 | | |
| | lanthanum 2-ethylhexanoate | 17.00 | | |
| Production | zirconium tetra-n-butoxide | 6.71 | 2-n- | 304 |
| Example B8 | tantalum pentaethoxide | 1.02 | butoxyethanol | |
| | lithium 2-ethylhexanoate | 10.2 | | |
| | lanthanum 2-ethylhexanoate | 17.00 | | |
| Production | zirconium tetra-n-butoxide | 6.71 | 2-n- | 304 |
| Example B9 | niobium pentaethoxide | 0.80 | butoxyethanol | |
| | lithium 2-ethylhexanoate | 10.20 | | |
| | lanthanum 2-ethylhexanoate | 17.00 | | |
| Production | zirconium tetra-n-butoxide | 5.00 | 2-n- | 304 |
| Example B10 | antimony tri-n-butoxide | 1.71 | butoxyethanol | |
| | tantalum pentaethoxide | 0.81 | | |
| | lithium nitrate | 4.34 | | |
| | lanthanum nitrate hexahydrate | 12.99 | | |

TABLE 3

| | Precursor oxide | | | Lithium compound | | Oxoacid compound | | Average | | | |
|---|---|---|---|---|---|---|---|---|---|---|---|
| | | Crystal grain | Content | | Content | | Content | particle | | | |
| | | diameter | XP | | XL | | XO | diameter | XO/ | XL/ | XO/ |
| | Crustal phase | [nm] | [mass %] | Formulation | [mass %] | Formulation | [mass %] | [μm] | XP | XP | XL |
| Production | pyrochlore-type | 20 | 70.4 | Li₂CO₃ | 21.3 | LiNO₃ | 1.83 | 3 | 0.026 | 0.30 | 0.086 |
| Example B1 | | | | | | | | | | | |
| Production | pyrochlore-type | 40 | 67.9 | Li₂CO₃ | 23.7 | Li₂SO₄ | 2.20 | 3 | 0.032 | 0.35 | 0.093 |
| Example B2 | | | | Li₂SO₄ | | | | | | | |
| Production | pyrochlore-type | 20 | 69.4 | Li₂CO₃ | 22.5 | LiNO₃ | 1.81 | 3 | 0.026 | 0.32 | 0.080 |
| Example B3 | | | | LiNO₃ | | | | | | | |
| Production | pyrochlore-type | 40 | 66.9 | Li₂CO₃ | 24.8 | Li₂SO₄ | 2.18 | 3 | 0.033 | 0.37 | 0.088 |
| Example B4 | | | | Li₂SO₄ | | | | | | | |
| Production | pyrochlore-type | 20 | 69.4 | Li₂CO₃ | 22.5 | LiNO₃ | 1.81 | 3 | 0.026 | 0.32 | 0.080 |
| Example B5 | | | | LiNO₃ | | | | | | | |
| Production | pyrochlore-type | 40 | 66.9 | Li₂CO₃ | 24.8 | Li₂SO₄ | 2.18 | 3 | 0.033 | 0.37 | 0.088 |
| Example B6 | | | | Li₂SO₄ | | | | | | | |
| Production | pyrochlore-type | 20 | 70.7 | Li₂CO₃ | 22.6 | — | — | 3 | 0 | 0.32 | 0 |
| Example B7 | | | | | | | | | | | |
| Production | pyrochlore-type | 20 | 71.3 | Li₂CO₃ | 22.1 | — | — | 3 | 0 | 0.31 | 0 |
| Example B8 | | | | | | | | | | | |
| Production | pyrochlore-type | 20 | 70.7 | Li₂CO₃ | 22.6 | — | — | 3 | 0 | 0.32 | 0 |
| Example B9 | | | | | | | | | | | |
| Production | garnet-type | — | 98 | — | — | — | — | 3 | 0 | 0 | — |
| Example B10 | | | | | | | | | | | |
| Production | garnet-type | — | 98 | — | — | — | — | 3 | 0 | 0 | — |
| Example B11 | | | | | | | | | | | |
| Production | garnet-type | — | 98 | — | — | — | — | 3 | 0 | 0 | — |
| Example B12 | | | | | | | | | | | |

### [7] Production of Solid Composition

### Example 1

50.0 parts by mass of the first particles obtained in the above Production Example A3, and 50.0 parts by mass of the second particles obtained in the above Production Example B1 were sufficiently mixed, whereby a solid composition was obtained.

### Examples 2 to 40

Solid compositions were produced in the same manner as in the above Example 1 except that the types of the first particles and the second particles, and the blending ratios thereof were changed as shown in Tables 4 and 5.

### Comparative Examples 1 to 16

Solid compositions were produced in the same manner as in the above Example 1 except that the types of the first particles and the second particles, and the blending ratios thereof were changed as shown in Table 5.

The configurations of the solid compositions of the respective Examples and the respective Comparative Examples are collectively shown in Tables 4 and 5.

TABLE 4

| | First particles | | | | Second particles | | |
|---|---|---|---|---|---|---|---|
| | | | Particle | Content | | Particle | Content |
| | | | diameter | XP | | diameter | X2 |
| | Type | Formulation | D1 [μm] | [mass %] | Type | D2 [μm] | [mass %] |
| Example 1 | A3 | Li₇La₃Zr₂O₁₂ | 5 | 50.0 | B1 | 3 | 50.0 |
| Example 2 | A3 | Li₇La₃Zr₂O₁₂ | 5 | 75.0 | B1 | 3 | 25.0 |
| Example 3 | A3 | Li₇La₃Zr₂O₁₂ | 5 | 87.5 | B1 | 3 | 12.5 |
| Example 4 | A3 | Li₇La₃Zr₂O₁₂ | 5 | 95.0 | B1 | 3 | 5.0 |
| Example 5 | A3 | Li₇La₃Zr₂O₁₂ | 1 | 75.0 | B1 | 3 | 25.0 |
| Example 6 | A5 | Li₇La₃Zr₂O₁₂ | 3 | 75.0 | B1 | 3 | 25.0 |
| Example 7 | A4 | Li₇La₃Zr₂O₁₂ | 5 | 75.0 | B1 | 3 | 25.0 |
| Example 8 | A2 | Li₇La₃Zr₂O₁₂ | 10 | 75.0 | B1 | 3 | 25.0 |
| Example 9 | A1 | Li₇La₃Zr₂O₁₂ | 20 | 75.0 | B1 | 3 | 25.0 |
| Example 10 | A3 | Li₇La₃Zr₂O₁₂ | 5 | 75.0 | B2 | 3 | 25.0 |
| Example 11 | A8 | Li_{1+x+y}AlₓTi₂₋ₓSi_{y}P_{3-y}O₁₂ | 5 | 50.0 | B3 | 3 | 50.0 |
| Example 12 | A8 | Li_{1+x+y}AlₓTi₂₋ₓSi_{y}P_{3-y}O₁₂ | 5 | 75.0 | B3 | 3 | 25.0 |
| Example 13 | A8 | Li_{1+x+y}AlₓTi₂₋ₓSi_{y}P_{3-y}O₁₂ | 5 | 87.5 | B3 | 3 | 12.5 |
| Example 14 | A8 | Li_{1+x+y}AlₓTi₂₋ₓSi_{y}P_{3-y}O₁₂ | 5 | 95.0 | B3 | 3 | 5.0 |
| Example 15 | A8 | Li_{1+x+y}AlₓTi₂₋ₓSi_{y}P_{3-y}O₁₂ | 1 | 75.0 | B3 | 3 | 25.0 |
| Example 16 | A10 | Li_{1+x+y}AlₓTi₂₋ₓSi_{y}P_{3-y}O₁₂ | 3 | 75.0 | B3 | 3 | 25.0 |
| Example 17 | A9 | Li_{1+x+y}AlₓTi₂₋ₓSi_{y}P_{3-y}O₁₂ | 5 | 75.0 | B3 | 3 | 25.0 |
| Example 18 | A7 | Li_{1+x+y}AlₓTi₂₋ₓSi_{y}P_{3-y}O₁₂ | 10 | 75.0 | B3 | 3 | 25.0 |
| Example 19 | A6 | Li_{1+x+y}AlₓTi₂₋ₓSi_{y}P_{3-y}O₁₂ | 20 | 75.0 | B3 | 3 | 25.0 |
| Example 20 | A8 | Li_{1+x+y}AlₓTi₂₋ₓSi_{y}P_{3-y}O₁₂ | 5 | 75.0 | B4 | 3 | 25.0 |
| Example 21 | A13 | Li_{0.29}La_{0.57}TiO₃ | 5 | 50.0 | B5 | 3 | 50.0 |
| Example 22 | A13 | Li_{0.29}La_{0.57}TiO₃ | 5 | 75.0 | B5 | 3 | 25.0 |
| Example 23 | A13 | Li_{0.29}La_{0.57}TiO₃ | 5 | 87.5 | B5 | 3 | 12.5 |
| Example 24 | A13 | Li_{0.29}La_{0.57}TiO₃ | 5 | 95.0 | B5 | 3 | 5.0 |
| Example 25 | A13 | Li_{0.29}La_{0.57}TiO₃ | 1 | 75.0 | B5 | 3 | 25.0 |
| Example 26 | A15 | Li_{0.29}La_{0.57}TiO₃ | 3 | 75.0 | B5 | 3 | 25.0 |
| Example 27 | A14 | Li_{0.29}La_{0.57}TiO₃ | 5 | 75.0 | B5 | 3 | 25.0 |
| Example 28 | A12 | Li_{0.29}La_{0.57}TiO₃ | 10 | 75.0 | B5 | 3 | 25.0 |

TABLE 5

| | First particles | | | | Second particles | | |
|---|---|---|---|---|---|---|---|
| | | | Particle | Content | | Particle | Content |
| | | | diameter | X1 | | diameter | X2 |
| | Type | Formulation | D1 [μm] | [mass %] | Type | D2 [μm] | [mass %] |
| Example 29 | A11 | Li_{0.29}La_{0.57}TiO₃ | 20 | 75.0 | B5 | 3 | 25.0 |
| Example 30 | A13 | Li_{0.29}La_{0.57}TiO₃ | 5 | 75.0 | B6 | 3 | 25.0 |
| Example 31 | A18 | Li_{6.3}La_{3.0}Zr_{1.3}Sb_{0.5}Ta_{0.2}O₁₂ | 5 | 50.0 | B1 | 3 | 50.0 |
| Example 32 | A18 | Li_{6.3}La_{3.0}Zr_{1.3}Sb_{0.5}Ta_{0.2}O₁₂ | 5 | 75.0 | B1 | 3 | 25.0 |
| Example 33 | A18 | Li_{6.3}La_{3.0}Zr_{1.3}Sb_{0.5}Ta_{0.2}O₁₂ | 5 | 87.5 | B1 | 3 | 12.5 |
| Example 34 | A18 | Li_{6.3}La_{3.0}Zr_{1.3}Sb_{0.5}Ta_{0.2}O₁₂ | 5 | 95.0 | B1 | 3 | 5.0 |
| Example 35 | A18 | Li_{6.3}La_{3.0}Zr_{1.3}Sb_{0.5}Ta_{0.2}O₁₂ | 1 | 75.0 | B1 | 3 | 25.0 |
| Example 36 | A20 | Li_{6.3}La_{3.0}Zr_{1.3}Sb_{0.5}Ta_{0.2}O₁₂ | 3 | 75.0 | B1 | 3 | 25.0 |
| Example 37 | A19 | Li_{6.3}La_{3.0}Zr_{1.3}Sb_{0.5}Ta_{0.2}O₁₂ | 5 | 75.0 | B1 | 3 | 25.0 |
| Example 38 | A17 | Li_{6.3}La_{3.0}Zr_{1.3}Sb_{0.5}Ta_{0.2}O₁₂ | 10 | 75.0 | B1 | 3 | 25.0 |
| Example 39 | A16 | Li_{6.3}La_{3.0}Zr_{1.3}Sb_{0.5}Ta_{0.2}O₁₂ | 20 | 75.0 | B1 | 3 | 25.0 |
| Example 40 | A18 | Li_{6.3}La_{3.0}Zr_{1.3}Sb_{0.5}Ta_{0.2}O₁₂ | 5 | 75.0 | B2 | 3 | 25.0 |
| Comparative | — | — | — | 0 | B1 | 3 | 100 |
| Example 1 | | | | | | | |
| Comparative | A3 | Li₇La₃Zr₂O₁₂ | 5 | 100 | — | — | 0 |
| Example 2 | | | | | | | |
| Comparative | A3 | Li₇La₃Zr₂O₁₂ | 5 | 75.0 | B7 | 3 | 25.0 |
| Example 3 | | | | | | | |
| Comparative | A3 | Li₇La₃Zr₂O₁₂ | 5 | 75.0 | B10 | 3 | 25.0 |
| Example 4 | | | | | | | |
| Comparative | — | — | — | 0 | B3 | 3 | 100 |
| Example 5 | | | | | | | |
| Comparative | A8 | Li_{1+x+y}AlₓTi₂₋ₓSi_{y}P_{3-y}O₁₂ | 5 | 100 | — | — | 0 |
| Example 6 | | | | | | | |
| Comparative | A8 | Li_{1+x+y}AlₓTi₂₋ₓSi_{y}P_{3-y}O₁₂ | 5 | 75.0 | B8 | 3 | 25.0 |
| Example 7 | | | | | | | |
| Comparative | A8 | Li_{1+x+y}AlₓTi₂₋ₓSi_{y}P_{3-y}O₁₂ | 5 | 75.0 | B11 | 3 | 25.0 |
| Example 8 | | | | | | | |
| Comparative | — | — | — | 0 | B5 | 3 | 100 |
| Example 9 | | | | | | | |
| Comparative | A13 | Li_{0.29}La_{0.57}TiO₃ | 5 | 100 | — | — | 0 |
| Example 10 | | | | | | | |
| Comparative | A13 | Li_{0.29}La_{0.57}TiO₃ | 5 | 75.0 | B9 | 3 | 25.0 |
| Example 11 | | | | | | | |
| Comparative | A13 | Li_{0.29}La_{0.57}TiO₃ | 5 | 75.0 | B12 | 3 | 25.0 |
| Example 12 | | | | | | | |
| Comparative | — | — | — | 0 | B1 | 3 | 100 |
| Example 13 | | | | | | | |
| Comparative | A18 | Li_{6.3}La_{3.0}Zr_{1.3}Sb_{0.5}Ta_{0.2}O₁₂ | 5 | 100 | — | — | 0 |
| Example 14 | | | | | | | |
| Comparative | A18 | Li_{6.3}La_{3.0}Zr_{1.3}Sb_{0.5}Ta_{0.2}O₁₂ | 5 | 75.0 | B7 | 3 | 25.0 |
| Example 15 | | | | | | | |
| Comparative | A18 | Li_{6.3}La_{3.0}Zr_{1.3}Sb_{0.5}Ta_{0.2}O₁₂ | 5 | 75.0 | B10 | 3 | 25.0 |
| Example 16 | | | | | | | |

### [8] Production of Solid Electrolyte Molded Body

By using the solid compositions of the respective Examples and the respective Comparative Examples, solid electrolyte molded bodies were produced as follows.

First, 1 g of a sample was taken out from each of the solid compositions.

Subsequently, each sample thereof was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and fired in an air atmosphere at 900° C. for 8 hours, whereby a solid electrolyte molded body in a pellet form was obtained.

With respect to the solid compositions of the respective Examples and the respective Comparative Examples and the solid electrolyte molded bodies obtained as described above using the solid compositions, an analysis was performed using an X-ray diffractometer X′Pert-PRO manufactured by Philips Electron Optics, Inc., whereby X-ray diffraction patterns were obtained.

As a result, it was confirmed that in the respective Examples, the precursor oxide contained in the solid composition and the second solid electrolyte formed from the precursor oxide are constituted by mutually different crystal phases.

The formulations of the regions corresponding to the second particles of the solid electrolyte molded bodies according to the respective Examples and the respective Comparative Examples are collectively shown in Tables 6 and 7.

TABLE 6

| | |
|---|---|
| Example 1 | Li_{6.3}La₃Zr_{1.3}Sb_{0.5}Ta_{0.2}O₁₂ |
| Example 2 | Li_{6.3}La₃Zr_{1.3}Sb_{0.5}Ta_{0.2}O₁₂ |
| Example 3 | Li_{6.3}La₃Zr_{1.3}Sb_{0.5}Ta_{0.2}O₁₂ |
| Example 4 | Li_{6.3}La₃Zr_{1.3}Sb_{0.5}Ta_{0.2}O₁₂ |
| Example 5 | Li_{6.3}La₃Zr_{1.3}Sb_{0.5}Ta_{0.2}O₁₂ |
| Example 6 | Li_{6.3}La₃Zr_{1.3}Sb_{0.5}Ta_{0.2}O₁₂ |
| Example 7 | Li_{6.3}La₃Zr_{1.3}Sb_{0.5}Ta_{0.2}O₁₂ |
| Example 8 | Li_{6.3}La₃Zr_{1.3}Sb_{0.5}Ta_{0.2}O₁₂ |
| Example 9 | Li_{6.3}La₃Zr_{1.3}Sb_{0.5}Ta_{0.2}O₁₂ |
| Example 10 | Li_{6.3}La₃Zr_{1.3}Sb_{0.5}Ta_{0.2}O₁₂ |
| Example 11 | Li_{6.75}La₃Zr_{1.75}Ta_{0.25}O₁₂ |
| Example 12 | Li_{6.75}La₃Zr_{1.75}Ta_{0.25}O₁₂ |
| Example 13 | Li_{6.75}La₃Zr_{1.75}Ta_{0.25}O₁₂ |
| Example 14 | Li_{6.75}La₃Zr_{1.75}Ta_{0.25}O₁₂ |
| Example 15 | Li_{6.75}La₃Zr_{1.75}Ta_{0.25}O₁₂ |
| Example 16 | Li_{6.75}La₃Zr_{1.75}Ta_{0.25}O₁₂ |
| Example 17 | Li_{6.75}La₃Zr_{1.75}Ta_{0.25}O₁₂ |
| Example 18 | Li_{6.75}La₃Zr_{1.75}Ta_{0.25}O₁₂ |
| Example 19 | Li_{6.75}La₃Zr_{1.75}Ta_{0.25}O₁₂ |
| Example 20 | Li_{6.75}La₃Zr_{1.75}Ta_{0.25}O₁₂ |
| Example 21 | Li_{6.75}La₃Zr_{1.75}Ta_{0.25}O₁₂ |
| Example 22 | Li_{6.75}La₃Zr_{1.75}Ta_{0.25}O₁₂ |
| Example 23 | Li_{6.75}La₃Zr_{1.75}Ta_{0.25}O₁₂ |
| Example 24 | Li_{6.75}La₃Zr_{1.75}Ta_{0.25}O₁₂ |
| Example 25 | Li_{6.75}La₃Zr_{1.75}Ta_{0.25}O₁₂ |
| Example 26 | Li_{6.75}La₃Zr_{1.75}Ta_{0.25}O₁₂ |
| Example 27 | Li_{6.75}La₃Zr_{1.75}Ta_{0.25}O₁₂ |
| Example 28 | Li_{6.75}La₃Zr_{1.75}Ta_{0.25}O₁₂ |

TABLE 7

| | |
|---|---|
| Example 29 | Li_{6.75}La₃Zr_{1.75}Ta_{0.25}O₁₂ |
| Example 30 | Li_{6.75}La₃Zr_{1.75}Ta_{0.25}O₁₂ |
| Example 31 | Li_{6.3}La₃Zr_{1.3}Sb_{0.5}Ta_{0.2}O₁₂ |
| Example 32 | Li_{6.3}La₃Zr_{1.3}Sb_{0.5}Ta_{0.2}O₁₂ |
| Example 33 | Li_{6.3}La₃Zr_{1.3}Sb_{0.5}Ta_{0.2}O₁₂ |
| Example 34 | Li_{6.3}La₃Zr_{1.3}Sb_{0.5}Ta_{0.2}O₁₂ |
| Example 35 | Li_{6.3}La₃Zr_{1.3}Sb_{0.5}Ta_{0.2}O₁₂ |
| Example 36 | Li_{6.3}La₃Zr_{1.3}Sb_{0.5}Ta_{0.2}O₁₂ |
| Example 37 | Li_{6.3}La₃Zr_{1.3}Sb_{0.5}Ta_{0.2}O₁₂ |
| Example 38 | Li_{6.3}La₃Zr_{1.3}Sb_{0.5}Ta_{0.2}O₁₂ |
| Example 39 | Li_{6.3}La₃Zr_{1.3}Sb_{0.5}Ta_{0.2}O₁₂ |
| Example 40 | Li_{6.3}La₃Zr_{1.3}Sb_{0.5}Ta_{0.2}O₁₂ |
| Comparative Example 1 | Li_{6.3}La₃Zr_{1.3}Sb_{0.5}Ta_{0.2}O₁₂ |
| Comparative Example 2 | — |
| Comparative Example 3 | Li_{6.3}La₃Zr_{1.3}Sb_{0.5}Ta_{0.2}O₁₂ |
| Comparative Example 4 | Li_{6.3}La₃Zr_{1.3}Sb_{0.5}Ta_{0.2}O₁₂ |
| Comparative Example 5 | Li_{6.75}La₃Zr_{1.75}Ta_{0.25}O₁₂ |
| Comparative Example 6 | — |
| Comparative Example 7 | Li_{6.75}La₃Zr_{1.75}Ta_{0.25}O₁₂ |
| Comparative Example 8 | Li_{6.75}La₃Zr_{1.75}Ta_{0.25}O₁₂ |
| Comparative Example 9 | Li_{6.75}La₃Zr_{1.75}Ta_{0.25}O₁₂ |
| Comparative Example 10 | — |
| Comparative Example 11 | Li_{6.75}La₃Zr_{1.75}Ta_{0.25}O₁₂ |
| Comparative Example 12 | Li_{6.75}La₃Zr_{1.75}Ta_{0.25}O₁₂ |
| Comparative Example 13 | Li_{6.3}La₃Zr_{1.3}Sb_{0.5}Ta_{0.2}O₁₂ |
| Comparative Example 14 | — |
| Comparative Example 15 | Li_{6.3}La₃Zr_{1.3}Sb_{0.5}Ta_{0.2}O₁₂ |
| Comparative Example 16 | Li_{6.3}La₃Zr_{1.3}Sb_{0.5}Ta_{0.2}O₁₂ |

### [9] Evaluation

The following evaluation was performed for the solid electrolyte molded bodies according to the respective Examples and the respective Comparative Examples obtained as described above.

### [9-1] Evaluation of Denseness

With respect to the solid electrolyte molded bodies according to the respective Examples and the respective Comparative Examples, the void ratio of the solid electrolyte molded body was determined from profilometry and gravimetry. It can be said that as the void ratio is smaller, the denseness is higher. Note that in all the solid electrolyte molded bodies according to the respective Examples and the respective Comparative Examples, the content of the liquid component was 0.1 mass % or less, and the content of the oxoacid compound was 10 ppm or less. Further, in the respective Examples, the second solid electrolyte formed from the constituent materials of the second particles all had a cubic garnet-type crystal phase.

### [9-2] Evaluation of Ion Conductivity

With respect to the solid electrolyte molded bodies according to the respective Examples and the respective Comparative Examples obtained in the above [9-1], a lithium metal foil having a diameter of 8 mm (manufactured by Honjo Chemical Corporation) was bonded to both faces, thereby forming activated electrodes, and the lithium ion conductivity was determined by measuring an AC impedance using an AC impedance analyzer Solartron 1260 (manufactured by Solartron Analytical, Inc.). The measurement was performed at an AC amplitude of 10 mV in a frequency range from 10⁷ Hz to 10⁻¹ Hz. The lithium ion conductivity obtained by the measurement shows the total lithium ion conductivity including the bulk lithium ion conductivity and the grain boundary lithium ion conductivity in each solid electrolyte molded body. It can be said that as this value is larger, the ion conductivity is higher.

These results are collectively shown in Tables 8 and 9.

TABLE 8

| | Denseness | |
|---|---|---|
| | Void ratio after firing | Ion conductivity |
| | [vol %] | [mS/cm] |
| Example 1 | 17 | 0.20 |
| Example 2 | 5 | 0.30 |
| Example 3 | 13 | 0.22 |
| Example 4 | 20 | 0.17 |
| Example 5 | 25 | 0.20 |
| Example 6 | 10 | 0.25 |
| Example 7 | 5 | 0.30 |
| Example 8 | 13 | 0.20 |
| Example 9 | 20 | 0.15 |
| Example 10 | 8 | 0.22 |
| Example 11 | 17 | 0.15 |
| Example 12 | 5 | 0.25 |
| Example 13 | 13 | 0.20 |
| Example 14 | 20 | 0.15 |
| Example 15 | 25 | 0.20 |
| Example 16 | 10 | 0.23 |
| Example 17 | 5 | 0.25 |
| Example 18 | 13 | 0.20 |
| Example 19 | 20 | 0.10 |
| Example 20 | 8 | 0.21 |
| Example 21 | 17 | 0.30 |
| Example 22 | 5 | 1.00 |
| Example 23 | 13 | 0.10 |
| Example 24 | 20 | 0.02 |
| Example 25 | 25 | 0.20 |
| Example 26 | 10 | 0.60 |
| Example 27 | 5 | 1.00 |
| Example 28 | 13 | 0.30 |

TABLE 9

| | Denseness | |
|---|---|---|
| | Void ratio after firing | Ion conductivity |
| | [vol %] | [mS/cm] |
| Example 29 | 20 | 0.10 |
| Example 30 | 8 | 0.80 |
| Example 31 | 17 | 0.50 |
| Example 32 | 5 | 1.20 |
| Example 33 | 13 | 0.70 |
| Example 34 | 20 | 0.20 |
| Example 35 | 25 | 0.30 |
| Example 36 | 10 | 0.80 |
| Example 37 | 5 | 1.20 |
| Example 38 | 13 | 0.50 |
| Example 39 | 15 | 0.30 |
| Example 40 | 8 | 1.00 |
| Comparative | 40 | 0.01 |
| Example 1 | | |
| Comparative | 25 | 0.001 |
| Example 2 | | |
| Comparative | 25 | 0.001 |
| Example 3 | | |
| Comparative | 25 | 0.001 |
| Example 4 | | |
| Comparative | 40 | 0.01 |
| Example 5 | | |
| Comparative | 25 | 0.001 |
| Example 6 | | |
| Comparative | 25 | 0.0001 |
| Example 7 | | |
| Comparative | 25 | 0.0001 |
| Example 8 | | |
| Comparative | 40 | 0.05 |
| Example 9 | | |
| Comparative | 25 | 0.001 |
| Example 10 | | |
| Comparative | 25 | 0.0001 |
| Example 11 | | |
| Comparative | 25 | 0.0001 |
| Example 12 | | |
| Comparative | 40 | 0.05 |
| Example 13 | | |
| Comparative | 25 | 0.01 |
| Example 14 | | |
| Comparative | 25 | 0.001 |
| Example 15 | | |
| Comparative | 25 | 0.001 |
| Example 16 | | |

As apparent from Tables 8 and 9, excellent results were obtained in the respective Examples. On the other hand, satisfactory results could not be obtained in the respective Comparative Examples.

Further, when the production of solid electrolyte molded bodies was attempted in the same manner as described above except that the condition of the firing temperature was changed within a range of 700° C. or higher and 1000° C. or lower using the solid compositions of the respective Examples and the respective Comparative Examples, in the respective Examples, the solid electrolyte molded bodies could be favorably produced, and excellent results were obtained in the same manner as described above. On the other hand, in Comparative Examples, there were some that were unmoldable particularly at a low temperature range, and even for the moldable ones, satisfactory results could not be obtained.

What is claimed is:

1. A solid composition, comprising:
first particles constituted by a first solid electrolyte containing at least lithium;
an oxide having a different formulation from the first solid electrolyte; and
an oxoacid compound.

2. The solid composition according to claim 1, wherein the oxide and the oxoacid compound are contained in second particles that are different from the first particles.

3. The solid composition according to claim 2, wherein 0.05≤ X2/X1≤ 1.20 in which X1 is a content [mass %] of the first particles in the solid composition and X2 is a content [mass %] of the second particles in the solid composition.

4. The solid composition according to claim 2, wherein 0.1≤ D2/D1≤ 2 in which D1 is an average particle diameter [μm] of the first particles and D2 is an average particle diameter [μm] of the second particles.

5. The solid composition according to claim 2, wherein
the second particles contain Li, La, Zr, and M, wherein M is at least one type of element selected from the group consisting of Nb, Ta, and Sb, and
a ratio of substance amounts of Li, La, Zr, and M contained in the second particles is 7−x:3:2−x:x, and a relationship: 0<x<2.0 is satisfied.

6. The solid composition according to claim 1, wherein the first particles have an average particle diameter of 1.0 μm or more and 30 μm or less.

7. The solid composition according to claim 1, wherein the oxoacid compound contains at least one of a nitrate ion and a sulfate ion as an oxoanion.

8. The solid composition according to claim 1, wherein 0.013≤ XO/XP≤ 0.58 in which XP is a content [mass %] of the oxide in the solid composition and XO is a content [mass %] of the oxoacid compound in the solid composition.

9. The solid composition according to claim 1, wherein
a crystal phase of the oxide is a pyrochlore-type crystal, and
a crystal phase of the first solid electrolyte is a cubic garnet-type crystal.

10. The solid composition according to claim 1, wherein the oxide has a crystal grain diameter of 10 nm or more and 200 nm or less.

11. A method for producing a solid electrolyte molded body, comprising:
a molding step of obtaining a molded body using the solid composition according to claim 1; and
a heat treatment step of subjecting the molded body to a heat treatment so as to react the oxide and the oxoacid compound in the solid composition to cause conversion to a second solid electrolyte thereby forming a solid electrolyte molded body containing the first solid electrolyte and the second solid electrolyte.

12. The method for producing a solid electrolyte molded body according to claim 11, wherein a heating temperature of the molded body in the heat treatment step is 700° C. or higher and 1000° C. or lower.
